(19) United States
(12) Patent Application Publication
(10) Pub. No.: US 2008/0071550 A1
(43) Pub. Date: Mar. 20, 2008

(54) METHOD AND APPARATUS TO ENCODE AND DECODE AUDIO SIGNAL BY USING BANDWIDTH EXTENSION TECHNIQUE

(75) Inventors: Eun-mi OH, Seongnam-si (KR); Ki-hyun Choo, Seoul (KR); Miao Lei, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/856,221

(22) Filed: Sep. 17, 2007

(30) Foreign Application Priority Data
Sep. 18, 2006 (KR) 2006-90152
Aug. 8, 2007 (KR) 2007-79781

(51) Int. Cl. G10L 19/00

(52) U.S. Cl. 704/500; 704/E19.022

(57) ABSTRACT

Provided are a method and apparatus to encode and decode an audio signal. According to the present invention, by splitting an input signal into a low band signal and a high band signal, converting each of the low band signal and the high band signal from the time domain to the frequency domain, performing quantization and context-dependant bitplane encoding on the converted low band signal, generating and encoding bandwidth extension information that represents a characteristic of the converted high band signal, and outputting the encoded bitplane and the encoded bandwidth extension information as an encoded result of the input signal, high frequency components may be efficiently encoded at a restricted bit rate, thereby improving the quality of an audio signal.

### CROSS-REFERENCE TO RELATED APPLICATIONS

This application claims the benefit of Korean Patent Application No. 10-2006-0090152, filed on Sep. 18, 2006, and Korean Patent Application No. 10-2007-0079781, filed on Aug. 8, 2007, in the Korean Intellectual Property Office, the disclosure of which is incorporated herein in its entirety by reference.

### BACKGROUND OF THE INVENTION

1. Field of the Invention

The present invention relates to a method and apparatus to encode and decode an audio signal, and more particularly, to a method and apparatus to encode and decode an audio signal by using a bandwidth extension technique.

2. Description of the Related Art

When audio signals are encoded or decoded, the quality of the audio signals needs to be maximized with respect to restricted bit rates. The amount of bits available at a low bit rate is small and thus an audio signal has to be encoded or decoded by reducing the frequency bandwidth of the audio signal. Accordingly, the quality of the audio signal may deteriorate.

In general, low frequency components are more important for humans to recognize audio signals in comparison with high frequency components. Thus, a method of improving the quality of audio signals by increasing the amount of bits allocated to encode the low frequency components and by reducing the amount of bits allocated to encode the high frequency components is required.

### SUMMARY OF THE INVENTION

The present invention provides a method and apparatus to encode an audio signal in which high frequency components are efficiently encoded at a restricted bit rate so that the quality of the audio signal is improved.

The present invention also provides a method and apparatus to efficiently decode high frequency components from a bitstream encoded at a restricted bit rate.

Additional aspects and utilities of the present general inventive concept will be set forth in part in the description which follows and, in part, will be obvious from the description, or may be learned by practice of the general inventive concept.

According to an aspect of the present invention, there is provided a method of encoding an audio signal, the method including (a) splitting an input signal into a low band signal and a high band signal; (b) converting each of the low band signal and the high band signal from a time domain to a frequency domain; (c) performing quantization and context-dependent bitplane encoding on the converted low band signal; (d) generating and encoding bandwidth extension information that represents a characteristic of the converted high band signal by using the converted low band signal; and (e) outputting an encoded bitplane and the encoded bandwidth extension information as an encoded result of the input signal.

According to another aspect of the present invention, there is provided a method of decoding an audio signal, the method including (a) receiving an encoded audio signal; (b) generating a low band signal by performing context-dependent decoding and inverse quantization on an encoded bitplane included in the encoded audio signal; (c) decoding encoded bandwidth extension information included in the encoded audio signal and generating a high band signal from the low band signal by using the decoded bandwidth extension information; (d) converting each of the low band signal and the high band signal from a frequency domain to a time domain by performing inverse modified discrete cosine transformation (MDCT) on each of the low band signal and the high band signal; and (e) combining the converted low band signal and the converted high band signal.

According to another aspect of the present invention, there is provided a computer readable recording medium having recorded thereon a computer program for executing a method of decoding an audio signal, the method including (a) receiving an encoded audio signal; (b) generating a low band signal by performing context-dependent decoding and inverse quantization on an encoded bitplane included in the encoded audio signal; (c) decoding encoded bandwidth extension information included in the encoded audio signal and generating a high band signal from the low band signal by using the decoded bandwidth extension information; (d) converting each of the low band signal and the high band signal from a frequency domain to a time domain by performing inverse modified discrete cosine transformation (MDCT) on each of the low band signal and the high band signal; and (e) combining the converted low band signal and the converted high band signal.

According to another aspect of the present invention, there is provided an apparatus for encoding an audio signal, the apparatus including a band splitting unit for splitting an input signal into a low band signal and a high band signal; a conversion unit for converting each of the low band signal and the high band signal from a time domain to a frequency domain; a low band encoding unit for performing quantization and context-dependent bitplane encoding on the converted low band signal; and a bandwidth extension encoding unit for generating and encoding bandwidth extension information that represents a characteristic of the converted high band signal by using the converted low band signal.

According to another aspect of the present invention, there is provided an apparatus for decoding an audio signal, the apparatus including a low band decoding unit for generating a low band signal by performing context-dependent decoding and inverse quantization on an encoded bitplane; a bandwidth extension decoding unit for decoding encoded bandwidth extension information and generating a high band signal from the low band signal by using the decoded bandwidth extension information; an inverse MDCT application unit for converting each of the low band signal and the high band signal from a frequency domain to a time domain by performing inverse modified discrete cosine transformation (MDCT) on each of the low band signal and the high band signal; and a band combination unit for combining the converted low band signal and the converted high band signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus to encode an audio signal, according to an embodiment of the present invention;

FIG. 2 is a block diagram of an apparatus to encode an audio signal, according to another embodiment of the present invention;

FIG. 3 is a block diagram of an apparatus to encode an audio signal, according to another embodiment of the present invention;

FIG. 4 is a block diagram of an apparatus to encode an audio signal, according to another embodiment of the present invention;

FIG. 5 is a block diagram of an apparatus to encode an audio signal, according to another embodiment of the present invention;

FIG. 6 is a block diagram of an apparatus to encode an audio signal, according to another embodiment of the present invention;

FIG. 7 is a block diagram of an apparatus to decode an audio signal, according to an embodiment of the present invention;

FIG. 8 is a block diagram of an apparatus to decode an audio signal, according to another embodiment of the present invention;

FIG. 9 is a block diagram of an apparatus to decode an audio signal, according to another embodiment of the present invention;

FIG. 10 is a block diagram of an apparatus to decode an audio signal, according to another embodiment of the present invention;

FIG. 11 is a block diagram of an apparatus to decode an audio signal, according to another embodiment of the present invention;

FIG. 12 is a block diagram of an apparatus to decode an audio signal, according to another embodiment of the present invention;

FIG. 13 is a flowchart of a method of encoding an audio signal, according to an embodiment of the present invention;

FIG. 14 is a flowchart of a method of encoding an audio signal, according to another embodiment of the present invention;

FIG. 15 is a flowchart of a method of encoding an audio signal, according to another embodiment of the present invention;

FIG. 16 is a flowchart of a method of decoding an audio signal, according to an embodiment of the present invention;

FIG. 17 is a flowchart of a method of decoding an audio signal, according to another embodiment of the present invention; and

FIG. 18 is a flowchart of a method of decoding an audio signal, according to another embodiment of the present invention.

### DETAILED DESCRIPTION OF THE PREFERRED EMBODIMENTS

Since a structural or functional description is provided to describe exemplary embodiments of the present invention, the invention may be embodied in many different forms and should not be construed as being limited to the embodiments set forth herein.

The present invention will now be described more fully with reference to the accompanying drawings, in which exemplary embodiments of the invention are shown. The exemplary embodiments should be considered in a descriptive sense only and not for purposes of limitation, and all differences within the scope will be construed as being included in the present invention. Like reference numerals in the drawings denote like elements.

Unless defined differently, all terms used in the description including technical and scientific terms have the same meaning as generally understood by those of ordinary skill in the art. Terms as defined in a commonly used dictionary should be construed as having the same meaning as in an associated technical context, and unless defined in the description, the terms are not ideally or excessively construed as having formal meaning.

Hereinafter, exemplary embodiments of the present invention will be described in detail with reference to the attached drawings. Like reference numerals in the drawings denote like elements and thus repeated descriptions will be omitted.

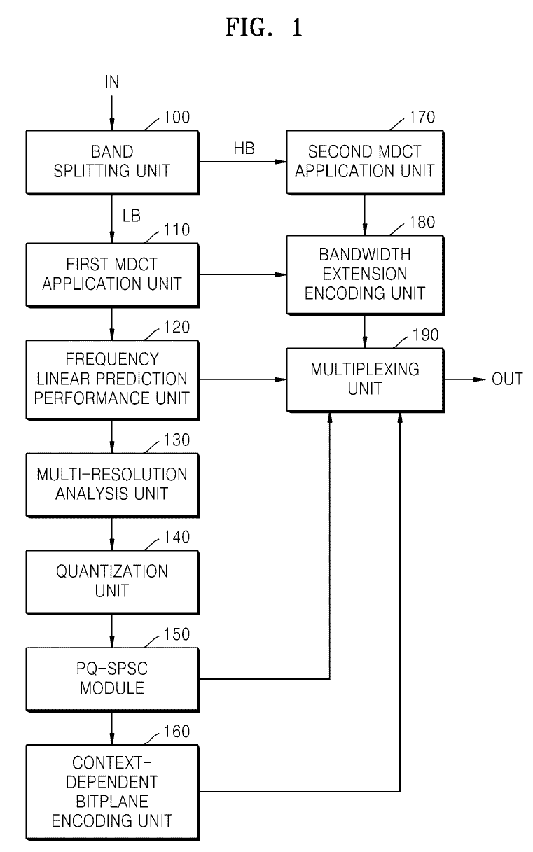

FIG. 1 is a block diagram of an apparatus to encode an audio signal, according to an embodiment of the present invention.

Referring to FIG. 1, the apparatus includes a band splitting unit 100, a first modified discrete cosine transformation (MDCT) application unit 110, a frequency linear prediction performance unit 120, a multi-resolution analysis unit 130, a quantization unit 140, a post-quantization square polar stereo coding (PQ-SPSC) module 150, a context-dependent bitplane encoding unit 160, a second MDCT application unit 170, a bandwidth extension encoding unit 180, and a multiplexing unit 190.

The band splitting unit 100 splits an input signal IN into a low band signal LB and a high band signal HB. Here, the input signal IN may be a pulse code modulation (PCM) signal by which an analog speech or audio signal is modulated into a digital signal, the low band signal LB may be a frequency signal lower than a predetermined threshold value, and the high band signal HB may be a frequency signal higher than the predetermined threshold value.

The first MDCT application unit 110 performs MDCT on the low band signal LB split by the band splitting unit 100 so as to convert the low band signal LB from the time domain to the frequency domain.

The frequency linear prediction performance unit 120 performs frequency linear prediction on the low band signal LB converted to the frequency domain by the first MDCT application unit 110. Here, the frequency linear prediction approximates a current frequency signal from a linear combination of previous frequency signals. In more detail, the frequency linear prediction performance unit 120 calculates coefficients of a linear prediction filter so as to minimize prediction errors that are differences between a linearly predicted signal and the current frequency signal, and performs linear prediction filtering using the calculated coefficients on the low band signal LB converted to the frequency domain. Here, the frequency linear prediction performance unit 120 may improve the encoding efficiency by performing vector quantization on corresponding values of coefficients of a linear prediction filter so as to represent the corresponding values by using vector indices.

In further detail, if the low band signal LB converted to the frequency domain by the first MDCT application unit 110 is a speech or pitched signal, the frequency linear prediction performance unit 120 may perform the frequency linear prediction on the speech signal or pitched signal. That is, the frequency linear prediction performance unit 120 may improve the encoding efficiency by performing the frequency linear prediction in accordance with a characteristic of a received signal.

The multi-resolution analysis unit 130 receives the low band signal LB converted to the frequency domain by the first MDCT application unit 110 or the result output from the frequency linear prediction performance unit 220, and performs multi-resolution analysis on audio spectrum coefficients of the received signal that change abruptly. In more detail, the multi-resolution analysis unit 230 may perform the multi-resolution analysis on an audio spectrum filtered by the frequency linear prediction performance unit 220 by dividing the audio spectrum into two types, such as a stable type and a short type, in accordance with the intensity of audio spectrum variations.

In further detail, if the low band signal LB converted to the frequency domain by the first MDCT application unit 110 or the result output from the frequency linear prediction performance unit 120 is a transient signal, the multi-resolution analysis unit 130 may perform the multi-resolution analysis on the transient signal. That is, the multi-resolution analysis unit 130 may improve the encoding efficiency by performing the multi-resolution analysis in accordance with a characteristic of the received signal.

The quantization unit 140 quantizes the result output from the frequency linear prediction performance unit 120 or the multi-resolution analysis unit 130.

The PQ-SPSC module 150 performs side-polar coordination stereo encoding on a frequency spectrum of the result output from the quantization unit 140.

The context-dependent bitplane encoding unit 160 performs context-dependent bitplane encoding on the result output from the PQ-SPSC module 150. Here, the context-dependent bitplane encoding unit 160 may perform the context-dependent bitplane encoding by using a Huffman coding method.

The frequency linear prediction performance unit 120, the multi-resolution analysis unit 130, the quantization unit 140, the PQ-SPSC module 150, and the context-dependent bitplane encoding unit 160 encode the low band signal LB output from the first MDCT application unit 110 and thus may be collectively referred to as a low band encoding unit.

The second MDCT application unit 170 performs MDCT on the high band signal HB split by the band splitting unit 100 so as to convert the high band signal HB from the time domain to the frequency domain.

The bandwidth extension encoding unit 180 generates and encodes bandwidth extension information that represents a characteristic of the high band signal HB converted to the frequency domain by the second MDCT application unit 170 by using the low band signal LB converted to the frequency domain by the first MDCT application unit 110. The bandwidth extension information may include various pieces of information, such as an energy level and an envelope, of the high band signal HB. In more detail, the bandwidth extension encoding unit 180 may generate the bandwidth extension information by using the low band signal LB based on the fact that high correlation between the low band signal LB and the high band signal HB exists.

The multiplexing unit 190 generates a bitstream by multiplexing the results encoded by the frequency linear prediction performance unit 120, the PQ-SPSC module 150, the context-dependent bitplane encoding unit 160, and the bandwidth extension encoding unit 180 so as to output the bitstream as an output signal OUT.

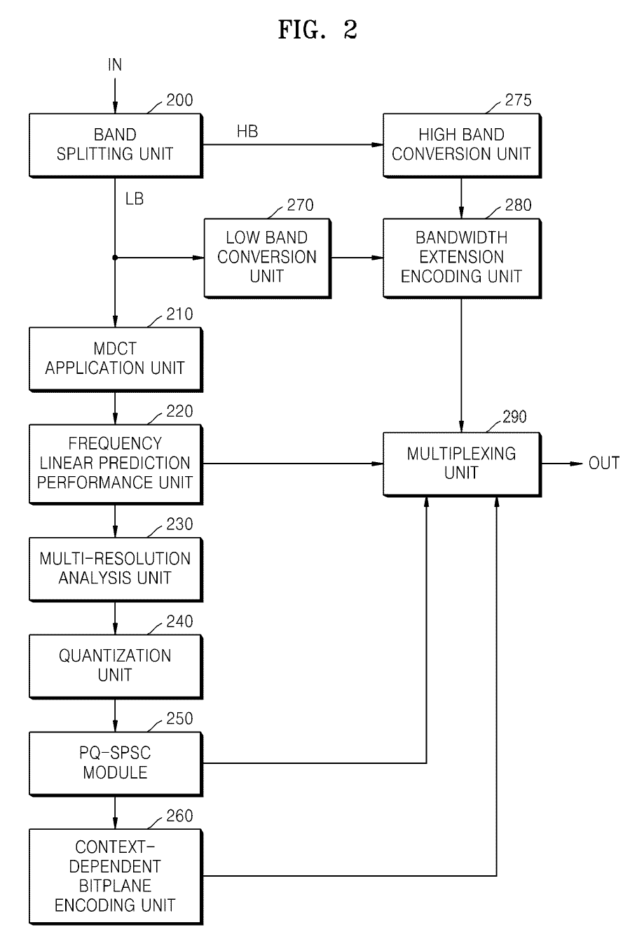

FIG. 2 is a block diagram of an apparatus to encode an audio signal, according to another embodiment of the present invention.

Referring to FIG. 2, the apparatus includes a band splitting unit 200, an MDCT application unit 210, a frequency linear prediction performance unit 220, a multi-resolution analysis unit 230, a quantization unit 240, a PQ-SPSC module 250, a context-dependent bitplane encoding unit 260, a low band conversion unit 270, a high band conversion unit 275, a bandwidth extension encoding unit 280, and a multiplexing unit 290.

The band splitting unit 200 splits an input signal IN into a low band signal LB and a high band signal HB. Here, the input signal IN may be a PCM signal in which an analog speech or audio signal is modulated into a digital signal, the low band signal LB may be a frequency signal lower than a predetermined threshold value, and the high band signal HB may be a frequency signal higher than the predetermined threshold value.

The MDCT application unit 210 performs MDCT on the low band signal LB split by the band splitting unit 200 so as to convert the low band signal LB from the time domain to the frequency domain.

The frequency linear prediction performance unit 220 performs frequency linear prediction on the low band signal LB converted to the frequency domain by the MDCT application unit 210. Here, the frequency linear prediction approximates a current frequency signal from a linear combination of previous frequency signals. In more detail, the frequency linear prediction performance unit 220 calculates coefficients of a linear prediction filter so as to minimize prediction errors that are differences between a linearly predicted signal and the current frequency signal, and performs linear prediction filtering using the calculated coefficients on the low band signal LB converted to the frequency domain. Here, the frequency linear prediction performance unit 220 may improve the encoding efficiency by performing vector quantization on corresponding values of coefficients of a linear prediction filter so as to represent the corresponding values by using vector indices.

In further detail, if the low band signal LB converted to the frequency domain by the MDCT application unit 210 is a speech or pitched signal, the frequency linear prediction performance unit 220 may perform the frequency linear prediction on the speech signal or pitched signal. That is, the frequency linear prediction performance unit 220 may improve the encoding efficiency by performing the frequency linear prediction in accordance with a characteristic of a received signal.

The multi-resolution analysis unit 230 receives the result output from the frequency linear prediction performance unit 220 and performs multi-resolution analysis on audio spectrum coefficients of the received signal that change abruptly. In more detail, the multi-resolution analysis unit 230 may perform the multi-resolution analysis on an audio spectrum filtered by the frequency linear prediction performance unit 220 by dividing the audio spectrum into two types, such as a stable type and a short type, in accordance with the intensity of audio spectrum variations.

In further detail, if the low band signal LB converted to the frequency domain by the MDCT application unit 210 or the result output from the frequency linear prediction performance unit 220 is a transient signal, the multi-resolution analysis unit 230 may perform the multi-resolution analysis on the transient signal. That is, the multi-resolution analysis unit 230 may improve the encoding efficiency by performing the multi-resolution analysis in accordance with a characteristic of the received signal.

The quantization unit 240 quantizes the result output from the frequency linear prediction performance unit 220 or the multi-resolution analysis unit 230.

The PQ-SPSC module 250 performs side-polar coordination stereo encoding on a frequency spectrum of the result output from the quantization unit 240.

The context-dependent bitplane encoding unit 260 performs context-dependent bitplane encoding on the result output from the PQ-SPSC module 250. Here, the context-dependent bitplane encoding unit 260 may perform the context-dependent bitplane encoding by using a Huffman coding method.

The frequency linear prediction performance unit 220, the multi-resolution analysis unit 230, the quantization unit 240, the PQ-SPSC module 250, and the context-dependent bitplane encoding unit 260 encode the low band signal LB output from the MDCT application unit 210, and thus may be collectively referred to as a low band encoding unit.

The low band conversion unit 270 converts the low band signal LB split by the band splitting unit 200 from the time domain to the frequency domain or the time/frequency domain by using a conversion method other than an MDCT method. For example, the low band conversion unit 270 may convert the low band signal LB from the time domain to the frequency domain or the time/frequency domain by using a modified discrete sine transformation (MDST) method, a fast Fourier transformation (FFT) method, or a quadrature mirror filter (QMF) method.

The high band conversion unit 275 converts the high band signal HB split by the band splitting unit 200 from the time domain to the frequency domain or the time/frequency domain by using a conversion method other than the MDCT method. Here, the high band conversion unit 275 and the low band conversion unit 270 use the same conversion method. For example, the high band conversion unit 275 may use the MDST method, the FFT method, or the QMF method.

The bandwidth extension encoding unit 280 generates and encodes bandwidth extension information that represents the characteristic of the high band signal HB converted to the frequency domain by the high band conversion unit 275 by using the low band signal LB converted to the frequency domain by the low band conversion unit 270. The bandwidth extension information may include various pieces of information, such as an energy level and an envelope, of the high band signal HB. In more detail, the bandwidth extension encoding unit 280 may generate the bandwidth extension information by using the low band signal LB based on the fact that a high correlation between the low band signal LB and the high band signal HB exists.

The multiplexing unit 290 generates a bitstream by multiplexing the results encoded by the frequency linear prediction performance unit 220, the PQ-SPSC module 250, the context-dependent bitplane encoding unit 260, and the bandwidth extension encoding unit 280 so as to output the bitstream as an output signal OUT.

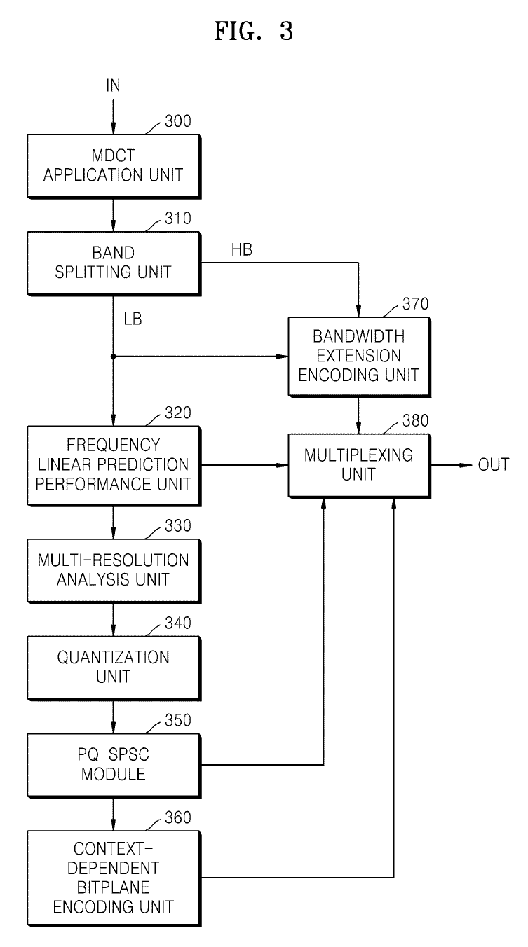

FIG. 3 is a block diagram of an apparatus to encode an audio signal, according to another embodiment of the present invention.

Referring to FIG. 3, the apparatus includes an MDCT application unit 300, a band splitting unit 310, a frequency linear prediction performance unit 320, a multi-resolution analysis unit 330, a quantization unit 340, a PQ-SPSC module 350, a context-dependent bitplane encoding unit 360, a bandwidth extension encoding unit 370, and a multiplexing unit 380.

The MDCT application unit 300 performs MDCT on an input signal IN so as to convert the input signal IN from the time domain to the frequency domain. Here, the input signal IN may be a PCM signal in which an analog speech or audio signal is modulated into a digital signal.

The band splitting unit 310 splits the input signal IN converted to the frequency domain by the MDCT application unit 300 into a low band signal LB and a high band signal HB. Here, the low band signal LB may be a frequency signal lower than a predetermined threshold value, and the high band signal HB may be a frequency signal higher than the predetermined threshold value.

The frequency linear prediction performance unit 320 performs frequency linear prediction on the low band signal LB split by the band splitting unit 310. Here, the frequency linear prediction approximates a current frequency signal from a linear combination of previous frequency signals. In more detail, the frequency linear prediction performance unit 320 calculates coefficients of a linear prediction filter so as to minimize prediction errors that are differences between a linearly predicted signal and the current frequency signal, and performs linear prediction filtering using the calculated coefficients on the low band signal LB converted to the frequency domain. Here, the frequency linear prediction performance unit 320 may improve the encoding efficiency by performing vector quantization on corresponding values of coefficients of a linear prediction filter so as to represent the corresponding values by using vector indices.

In further detail, if the low band signal LB split by the band splitting unit 310 is a speech or pitched signal, the frequency linear prediction performance unit 320 may perform the frequency linear prediction on the speech signal or pitched signal. That is, the frequency linear prediction performance unit 320 may improve the encoding efficiency by performing the frequency linear prediction in accordance with a characteristic of a received signal.

The multi-resolution analysis unit 330 receives the result output from the frequency linear prediction performance unit 320, and performs multi-resolution analysis on audio spectrum coefficients of the received signal that change abruptly. In more detail, the multi-resolution analysis unit 330 may perform the multi-resolution analysis on an audio spectrum filtered by the frequency linear prediction performance unit 320 by dividing the audio spectrum into two types, such as a stable type and a short type, in accordance with the intensity of audio spectrum variations.

In further detail, if the low band signal LB split by the band splitting unit 310 or the result output from the frequency linear prediction performance unit 320 is a transient signal, the multi-resolution analysis unit 330 may perform the multi-resolution analysis on the transient signal. That is, the multi-resolution analysis unit 330 may improve the encoding efficiency by performing the multi-resolution analysis in accordance with a characteristic of the received signal.

The quantization unit 340 quantizes the result output from the frequency linear prediction performance unit 320 or the multi-resolution analysis unit 330.

The PQ-SPSC module 350 performs side-polar coordination stereo encoding on a frequency spectrum of the result output from the quantization unit 340.

The context-dependent bitplane encoding unit 360 performs context-dependent bitplane encoding on the result output from the PQ-SPSC module 350. Here, the context-dependent bitplane encoding unit 360 may perform the context-dependent bitplane encoding by using a Huffman coding method.

The frequency linear prediction performance unit 320, the multi-resolution analysis unit 330, the quantization unit 340, the PQ-SPSC module 350, and the context-dependent bitplane encoding unit 360 encode the low band signal LB output from the MDCT application unit 310 and thus may be collectively referred to as a low band encoding unit.

The bandwidth extension encoding unit 370 generates and encodes bandwidth extension information that represents the characteristic of the high band signal HB split by the band splitting unit 310 by using the low band signal LB split by the band splitting unit 310. The bandwidth extension information may include various pieces of information, such as an energy level and an envelope, of the high band signal HB. In more detail, the bandwidth extension encoding unit 370 may generate the bandwidth extension information by using the low band signal LB based on the fact that a high correlation between the low band signal LB and the high band signal HB exists.

The multiplexing unit 380 generates a bitstream by multiplexing the results encoded by the frequency linear prediction performance unit 320, the PQ-SPSC module 350, the context-dependent bitplane encoding unit 360, and the bandwidth extension encoding unit 370 so as to output the bitstream as an output signal OUT.

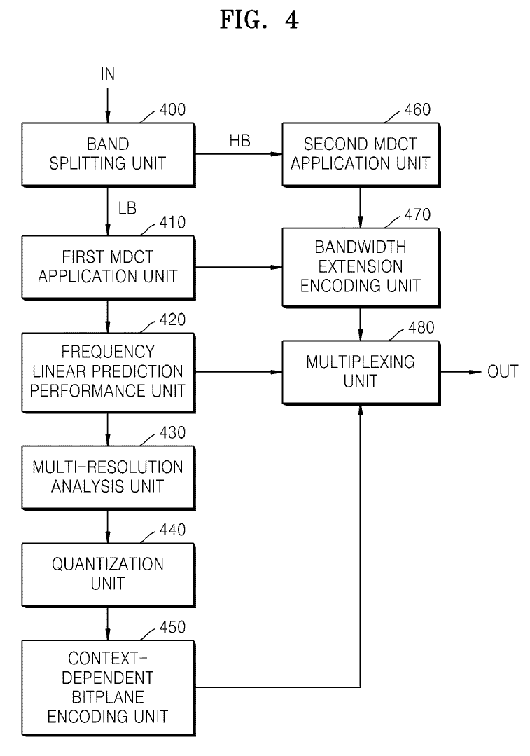

FIG. 4 is a block diagram of an apparatus to encode an audio signal, according to another embodiment of the present invention.

Referring to FIG. 4, the apparatus includes a band splitting unit 400, a first MDCT application unit 410, a frequency linear prediction performance unit 420, a multi-resolution analysis unit 430, a quantization unit 440, a context-dependent bitplane encoding unit 450, a second MDCT application unit 460, a bandwidth extension encoding unit 470, and a multiplexing unit 480.

The band splitting unit 400 splits an input signal IN into a low band signal LB and a high band signal HB. Here, the input signal IN may be a PCM signal in which an analog speech or audio signal is modulated into a digital signal, the low band signal LB may be a frequency signal lower than a predetermined threshold value, and the high band signal HB may be a frequency signal higher than the predetermined threshold value.

The first MDCT application unit 410 performs MDCT on the low band signal LB split by the band splitting unit 400 so as to convert the low band signal LB from the time domain to the frequency domain. Here, the time domain represents variations over time in amplitude, such as of energy or sound pressure of the input signal IN, and the frequency domain represents variations in the frequency components of the input signal IN.

The frequency linear prediction performance unit 420 performs frequency linear prediction on the low band signal LB converted to the frequency domain by the first MDCT application unit 410. Here, the frequency linear prediction approximates a current frequency signal from a linear combination of a previous frequency signal. In more detail, the frequency linear prediction performance unit 420 calculates coefficients of a linear prediction filter so as to minimize prediction errors that are differences between a linearly predicted signal and the current frequency signal, and performs linear prediction filtering using the calculated coefficients on the low band signal LB converted to the frequency domain. Here, the frequency linear prediction performance unit 420 may improve the encoding efficiency by performing vector quantization on corresponding values of coefficients of a linear prediction filter so as to represent the corresponding values by using vector indices.

In further detail, if the low band signal LB converted to the frequency domain by the first MDCT application unit 410 is a speech or pitched signal, the frequency linear prediction performance unit 420 may perform the frequency linear prediction on the speech signal or pitched signal. That is, the frequency linear prediction performance unit 420 may improve the encoding efficiency by performing the frequency linear prediction in accordance with a characteristic of a received signal.

The multi-resolution analysis unit 430 receives the result output from the frequency linear prediction performance unit 420, and performs multi-resolution analysis on audio spectrum coefficients of the received signal that change abruptly. In more detail, the multi-resolution analysis unit 430 may perform the multi-resolution analysis on an audio spectrum filtered by the frequency linear prediction performance unit 420 by dividing the audio spectrum into two types, such as a stable type and a short type, in accordance with the characteristics of audio spectrum variations.

In further detail, if the low band signal LB converted to the frequency domain by the first MDCT application unit 410 or the result output from the frequency linear prediction performance unit 420 is a transient signal, the multi-resolution analysis unit 430 may perform the multi-resolution analysis on the transient signal. That is, the multi-resolution analysis unit 430 may improve the encoding efficiency by performing the multi-resolution analysis in accordance with a characteristic of the received signal.

The quantization unit 440 quantizes the result output from the frequency linear prediction performance unit 420 or the multi-resolution analysis unit 430.

The context-dependent bitplane encoding unit 450 performs context-dependent bitplane encoding on the result output from the quantization unit 440. Here, the context-dependent bitplane encoding unit 450 may perform the context-dependent bitplane encoding by using a Huffman coding method.

The frequency linear prediction performance unit 420, the multi-resolution analysis unit 430, the quantization unit 440, and the context-dependent bitplane encoding unit 450 encode the low band signal LB output from the first MDCT application unit 410 and thus may be collectively referred to as a low band encoding unit.

The second MDCT application unit 460 performs the MDCT on the high band signal HB split by the band splitting unit 400 so as to convert the high band signal HB from the time domain to the frequency domain.

The bandwidth extension encoding unit 470 generates and encodes bandwidth extension information that represents a characteristic of the high band signal HB converted to the frequency domain by the second MDCT application unit 460 by using the low band signal LB converted to the frequency domain by the first MDCT application unit 410 The bandwidth extension information may include various pieces of information, such as an energy level and an envelope, of the high band signal HB. In more detail, the bandwidth extension encoding unit 470 may generate the bandwidth extension information by using the low band signal LB based on the fact that a high correlation between the low band signal LB and the high band signal HB exists.

The multiplexing unit 480 generates a bitstream by multiplexing the results encoded by the frequency linear prediction performance unit 420, the context-dependent bitplane encoding unit 450, and the bandwidth extension encoding unit 470 so as to output the bitstream as an output signal OUT.

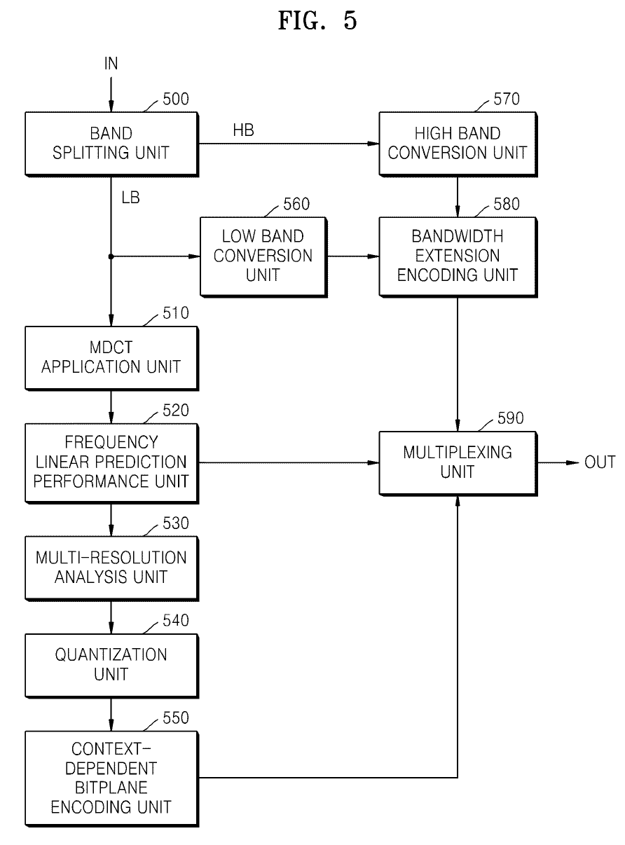

FIG. 5 is a block diagram of an apparatus to encode an audio signal, according to another embodiment of the present invention.

Referring to FIG. 5, the apparatus includes a band splitting unit 500, an MDCT application unit 510, a frequency linear prediction performance unit 520, a multi-resolution analysis unit 530, a quantization unit 540, a context-dependent bitplane encoding unit 550, a low band conversion unit 560, a high band conversion unit 570, a bandwidth extension encoding unit 580, and a multiplexing unit 590.

The band splitting unit 500 splits an input signal IN into a low band signal LB and a high band signal HB. Here, the input signal IN may be a PCM signal in which an analog speech or audio signal is modulated into a digital signal, the low band signal LB may be a frequency signal lower than a predetermined threshold value, and the high band signal HB may be a frequency signal higher than the predetermined threshold value.

The MDCT application unit 510 performs MDCT on the low band signal LB split by the band splitting unit 500 so as to convert the low band signal LB from the time domain to the frequency domain.

The frequency linear prediction performance unit 520 performs frequency linear prediction on the low band signal LB converted to the frequency domain by the MDCT application unit 510. Here, the frequency linear prediction approximates a current frequency signal from a linear combination of previous frequency signals. In more detail, the frequency linear prediction performance unit 520 calculates coefficients of a linear prediction filter so as to minimize prediction errors that are differences between a linearly predicted signal and the current frequency signal, and performs linear prediction filtering using the calculated coefficients on the low band signal LB converted to the frequency domain. Here, the frequency linear prediction performance unit 520 may improve the encoding efficiency by performing vector quantization on corresponding values of coefficients of a linear prediction filter so as to represent the corresponding values by using vector indices.

In further detail, if the low band signal LB converted to the frequency domain by the MDCT application unit 510 is a speech or pitched signal, the frequency linear prediction performance unit 520 may perform the frequency linear prediction on the speech signal or pitched signal. That is, the frequency linear prediction performance unit 520 may improve the encoding efficiency by performing the frequency linear prediction in accordance with a characteristic of a received signal.

The multi-resolution analysis unit 530 receives the result output from the frequency linear prediction performance unit 520, and performs multi-resolution analysis on audio spectrum coefficients of the received signal that changes abruptly. In more detail, the multi-resolution analysis unit 530 may perform the multi-resolution analysis on an audio spectrum filtered by the frequency linear prediction performance unit 520 by dividing the audio spectrum into two types, such as a stable type and a short type, in accordance with the characteristics of audio spectrum variations.

In further detail, if the low band signal LB converted to the frequency domain by the MDCT application unit 510 or the result output from the frequency linear prediction performance unit 520 is a transient signal, the multi-resolution analysis unit 530 may perform the multi-resolution analysis on the transient signal. That is, the multi-resolution analysis unit 530 may improve the encoding efficiency by performing the multi-resolution analysis in accordance with a characteristic of the received signal.

The quantization unit 540 quantizes the result output from the frequency linear prediction performance unit 520 or the multi-resolution analysis unit 530.

The context-dependent bitplane encoding unit 550 performs context-dependent bitplane encoding on the result output from the quantization unit 540. Here, the context-dependent bitplane encoding unit 550 may perform the context-dependent bitplane encoding by using a Huffman coding method.

The frequency linear prediction performance unit 520, the multi-resolution analysis unit 530, the quantization unit 540, and the context-dependent bitplane encoding unit 550 encode the low band signal LB output from the MDCT application unit 510 and thus may be collectively referred to as a low band encoding unit.

The low band conversion unit 560 converts the low band signal LB split by the band splitting unit 500 from the time domain to the frequency domain or the time/frequency domain by using a conversion method other than the MDCT method. For example, the low band conversion unit 560 may convert the low band signal LB from the time domain to the frequency domain or the time/frequency domain by using an MDST method, a FFT method, or a QMF method. Here, the time domain represents variations over time in amplitude, such as energy or sound pressure of the low band signal LB, the frequency domain represents frequency components of the low band signal LB according to frequency, and the time/frequency domain represents variations in frequency of the low band signal LB over time.

The high band conversion unit 570 converts the high band signal HB split by the band splitting unit 500 from the time domain to the frequency domain or the time/frequency domain by using a conversion method other than the MDCT method. Here, the high band conversion unit 570 and the low band conversion unit 560 use the same conversion method. For example, the high band conversion unit 570 may use the MDST method, the FFT method, or the QMF method.

The bandwidth extension encoding unit 580 generates and encodes bandwidth extension information that represents a characteristic of the high band signal HB converted to the frequency domain by the high band conversion unit 570 by using the low band signal LB converted to the frequency domain by the low band conversion unit 560 The bandwidth extension information may include various pieces of information, such as an energy level and an envelope, of the high band signal HB. In more detail, the bandwidth extension encoding unit 580 may generate the bandwidth extension information by using the low band signal LB based on the fact that high correlation between the low band signal LB and the high band signal HB exists.

The multiplexing unit 590 generates a bitstream by multiplexing the results encoded by the frequency linear prediction performance unit 520, the context-dependent bitplane encoding unit 550, and the bandwidth extension encoding unit 580 so as to output the bitstream as an output signal OUT.

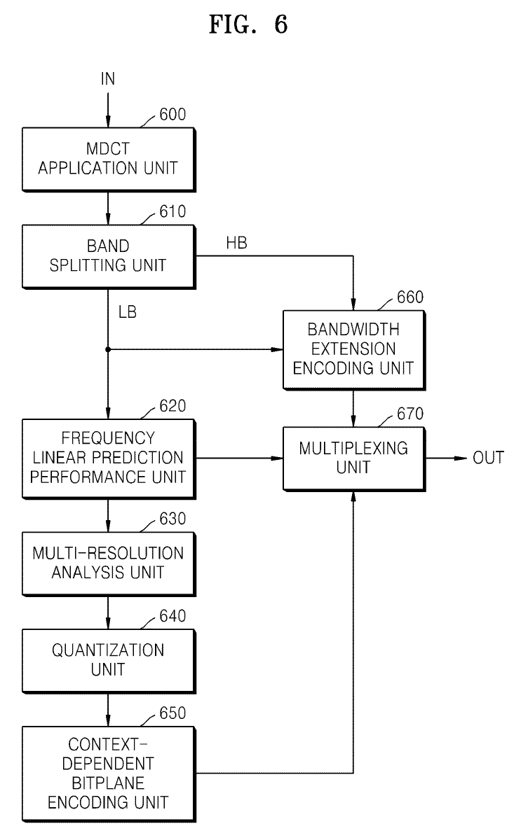

FIG. 6 is a block diagram of an apparatus to encode an audio signal, according to another embodiment of the present invention.

Referring to FIG. 6, the apparatus includes an MDCT application unit 600, a band splitting unit 610, a frequency linear prediction performance unit 620, a multi-resolution analysis unit 630, a quantization unit 640, a context-dependent bitplane encoding unit 650, a bandwidth extension encoding unit 660, and a multiplexing unit 670.

The MDCT application unit 600 performs MDCT on an input signal IN so as to convert the input signal IN from the time domain to the frequency domain. Here, the input signal IN may be a PCM signal in which an analog speech or audio signal is modulated into a digital signal.

The band splitting unit 610 splits the input signal IN converted to the frequency domain by the MDCT application unit 600 into a low band signal LB and a high band signal HB. Here, the low band signal LB may be a frequency signal lower than a predetermined threshold value, and the high band signal HB may be a frequency signal higher than the predetermined threshold value.

The frequency linear prediction performance unit 620 performs frequency linear prediction on the low band signal LB split by the band splitting unit 610. Here, the frequency linear prediction approximates a current frequency signal from a linear combination of previous frequency signals. In more detail, the frequency linear prediction performance unit 620 calculates coefficients of a linear prediction filter so as to minimize prediction errors that are differences between a linearly predicted signal and the current frequency signal, and performs linear prediction filtering using the calculated coefficients on the low band signal LB converted to the frequency domain. Here, the frequency linear prediction performance unit 620 may improve the encoding efficiency by performing vector quantization on corresponding values of coefficients of a linear prediction filter so as to represent the corresponding values by using vector indices.

In further detail, if the low band signal LB split by the band splitting unit 610 is a speech or pitched signal, the frequency linear prediction performance unit 620 may perform the frequency linear prediction on the speech signal or pitched signal. That is, the frequency linear prediction performance unit 620 may improve the encoding efficiency by performing the frequency linear prediction in accordance with a characteristic of a received signal.

The multi-resolution analysis unit 630 receives the result output from the frequency linear prediction performance unit 620, and performs multi-resolution analysis on audio spectrum coefficients of the received signal that instantaneously varies. In more detail, the multi-resolution analysis unit 630 may perform the multi-resolution analysis on an audio spectrum filtered by the frequency linear prediction performance unit 620 by dividing the audio spectrum into two types, such as a stable type and a short type, in accordance with the audio spectrum variations.

In further detail, if the low band signal LB split by the band splitting unit 610 or the result output from the frequency linear prediction performance unit 620 is a transient signal, the multi-resolution analysis unit 630 may perform the multi-resolution analysis on the transient signal. That is, the multi-resolution analysis unit 630 may improve the encoding efficiency by performing the multi-resolution analysis in accordance with a characteristic of the received signal.

The quantization unit 640 quantizes the result output from the frequency linear prediction performance unit 620 or the multi-resolution analysis unit 630.

The context-dependent bitplane encoding unit 650 performs context-dependent bitplane encoding on the result output from the quantization unit 640. Here, the context-dependent bitplane encoding unit 650 may perform the context-dependent bitplane encoding by using a Huffman coding method.

The frequency linear prediction performance unit 620, the multi-resolution analysis unit 630, the quantization unit 640, and the context-dependent bitplane encoding unit 650 encode the low band signal LB output from the MDCT application unit 610 and thus may be collectively referred to as a low band encoding unit.

The bandwidth extension encoding unit 660 generates and encodes bandwidth extension information that represents a characteristic of the high band signal HB split by the band splitting unit 610 by using the low band signal LB split by the band splitting unit 610. The bandwidth extension information may include various pieces of information, such as an energy level and an envelope, of the high band signal HB. In more detail, the bandwidth extension encoding unit 660 may generate the bandwidth extension information by using the low band signal LB based on the fact that a high correlation between the low band signal LB and the high band signal HB exists.

The multiplexing unit 670 generates a bitstream by multiplexing the results encoded by the frequency linear prediction performance unit 620, the context-dependent bitplane encoding unit 650, and the bandwidth extension encoding unit 660 so as to output the bitstream as an output signal OUT.

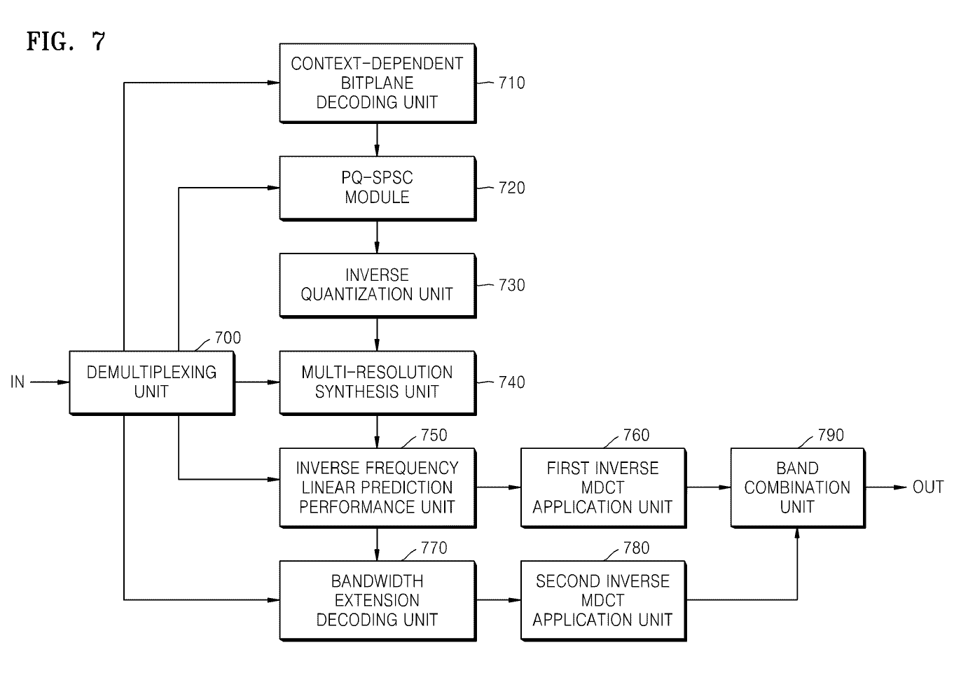

FIG. 7 is a block diagram of an apparatus to decode an audio signal, according to an embodiment of the present invention.

Referring to FIG. 7, the apparatus includes a demultiplexing unit 700, a context-dependent bitplane decoding unit 710, a PQ-SPSC module 720, an inverse quantization unit 730, a multi-resolution synthesis unit 740, an inverse frequency linear prediction performance unit 750, a first inverse MDCT application unit 760, a bandwidth extension decoding unit 770, a second inverse MDCT application unit 780, and a band combination unit 790.

The demultiplexing unit 700 receives and demultiplexes a bitstream output from an encoding terminal. In more detail, the demultiplexing unit 700 splits the bitstream into data pieces corresponding to various data levels, and analyzes and outputs information of the bitstream with regard to the data pieces. Here, the information output from the demultiplexing unit 700 includes analysis information on an audio spectrum to be used by the PQ-SPSC module 720, quantization values and other reconstruction information, reconstruction information of a quantization spectrum, information on context-dependant bitplane decoding, information on quantization wide-polar coordination stereo decoding, signal type information, information on frequency linear prediction and vector quantization, and encoded bandwidth extension information.

The context-dependent bitplane decoding unit 710 performs context-dependent decoding on an encoded bitplane. Here, the context-dependent bitplane decoding unit 710 receives the information output from the demultiplexing unit 700 and reconstructs a frequency spectrum, coding band mode information, and a scale factor by using a Huffman coding method. The context-dependent bitplane decoding unit 710 receives prejudice coding band mode information, a scale factor of prejudice coding, and a frequency spectrum of prejudice coding, and outputs coding band mode values, a decoding cosmetic indication of the scale factor, and quantization values of the frequency spectrum.

The PQ-SPSC module 720 receives the result output from the context-dependent bitplane decoding unit 710 and performs side-polar coordination stereo decoding on the frequency spectrum of the result. Here, the PQ-SPSC module 720 performs the side-polar coordination stereo decoding by receiving coupling information between the frequency spectrum and side-polar coordination stereo signals and then outputs a quantization frequency spectrum.

The inverse quantization unit 730 inverse quantizes the result output from the PQ-SPSC module 720.

The multi-resolution synthesis unit 740 receives the result output from the inverse quantization unit 730 and performs multi-resolution synthesis on audio spectrum coefficients of the received signal that change abruptly. In more detail, the multi-resolution synthesis unit 740 may improve the decoding efficiency by performing the multi-resolution synthesis on the result output from the inverse quantization unit 730 if multi-resolution analysis has been performed on an audio signal received from the encoding terminal. Here, the multi-resolution synthesis unit 740 receives an inverse quantization spectrum/difference spectrum and outputs a reconstruction spectrum/difference spectrum.

The inverse frequency linear prediction performance unit 750 combines the result output from the inverse quantization unit 730 or the multi-resolution synthesis unit 740 and the result of frequency linear prediction by the encoding terminal which is received from the demultiplexing unit 700. In more detail, if frequency linear prediction has been performed on the audio signal received from the encoding terminal, the inverse frequency linear prediction performance unit 750 may improve the decoding efficiency by combining the result of the frequency linear prediction and the result output from the inverse quantization unit 730 or the multi-resolution synthesis unit 740. Here, the inverse frequency linear prediction performance unit 750 efficiently improves the decoding efficiency by employing a frequency domain prediction technology and a vector quantization technology of prediction coefficients. The inverse frequency linear prediction performance unit 750 receives difference spectrum coefficients and vector indices and outputs MDCT spectrum coefficients.

The context-dependent bitplane decoding unit 710, the PQ-SPSC module 720, the inverse quantization unit 730, the multi-resolution synthesis unit 740, and the inverse frequency linear prediction performance unit 750 decode an encoded low band signal and thus may be collectively referred to as a low band decoding unit.

The first inverse MDCT application unit 760 performs an inverse operation of the conversion performed by the encoding terminal. The first inverse MDCT application unit 760 performs inverse MDCT on a low band signal output from the multi-resolution synthesis unit 740 and the inverse frequency linear prediction performance unit 750 so as to convert the low band signal from the frequency domain to the time domain. Here, the first inverse MDCT application unit 760 receives frequency spectrum coefficients obtained from the result of inverse quantization by the multi-resolution synthesis unit 740 or the inverse frequency linear prediction performance unit 750 and outputs reconstructed audio data that corresponds to a low band.

The bandwidth extension decoding unit 770 decodes the encoded bandwidth extension information and generates a high band signal from the low band signal output from the multi-resolution synthesis unit 740 or the inverse frequency linear prediction performance unit 750 by using the decoded bandwidth extension information. Here, the bandwidth extension decoding unit 770 generates the high band signal by applying the decoded bandwidth extension information to the low band signal based on the fact that a high correlation exists between the low band signal and the high band signal. Here, the bandwidth extension information represents a characteristic of the high band signal and includes various pieces of information, such as an energy level and an envelope, of the high band signal.

The second inverse MDCT application unit 780 performs inverse MDCT on the high band signal decoded by the bandwidth extension decoding unit 770 so as to convert the high band signal from the frequency domain to the time domain.

The band combination unit 790 combines the low band signal converted to the time domain by the first inverse MDCT application unit 760 and the high band signal converted to the time domain by the second inverse MDCT application unit 780 so as to output the result as an output signal OUT.

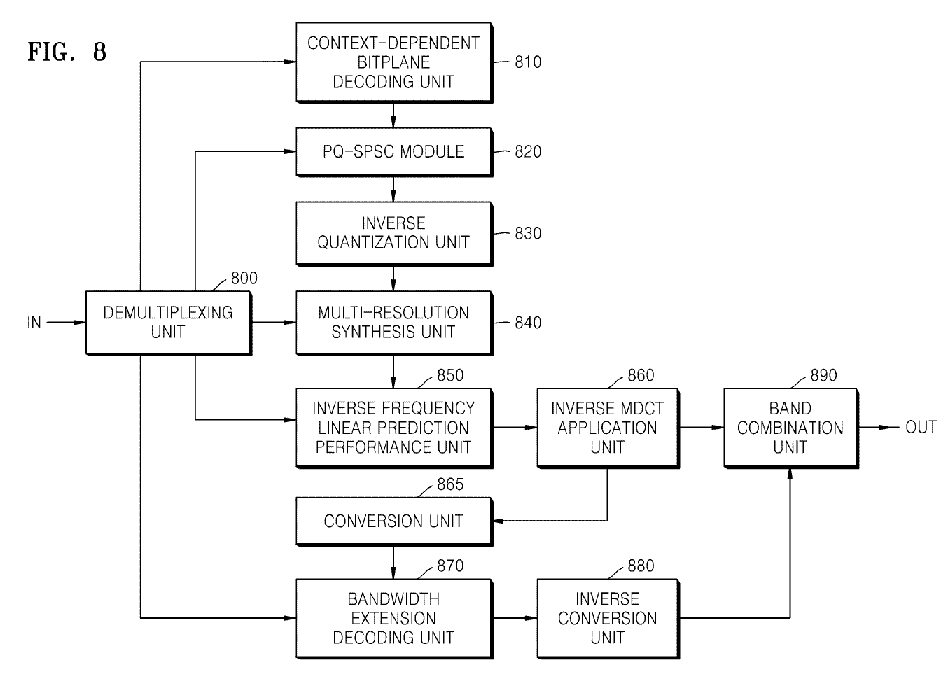

FIG. 8 is a block diagram of an apparatus to decode an audio signal, according to another embodiment of the present invention.

Referring to FIG. 8, the apparatus includes a demultiplexing unit 800, a context-dependent bitplane decoding unit 810, a PQ-SPSC module 820, an inverse quantization unit 830, a multi-resolution synthesis unit 840, an inverse frequency linear prediction performance unit 850, an inverse MDCT application unit 860, a conversion unit 865, a bandwidth extension decoding unit 870, an inverse conversion unit 880, and a band combination unit 890.

The demultiplexing unit 800 receives and demultiplexes a bitstream output from an encoding terminal. In more detail, the demultiplexing unit 800 splits the bitstream into data pieces corresponding to various data levels, and analyzes and outputs information of the bitstream with regard to the data pieces. Here, the information output from the demultiplexing unit 800 includes analysis information on an audio spectrum to be used by the PQ-SPSC module 820, quantization values and other reconstruction information, reconstruction information of a quantization spectrum, information on context-dependent bitplane decoding, information on quantization wide-polar coordination stereo decoding, signal type information, information on frequency linear prediction and vector quantization, and encoded bandwidth extension information.

The context-dependent bitplane decoding unit 810 performs context-dependent decoding on an encoded bitplane. Here, the context-dependent bitplane decoding unit 810 receives the information output from the demultiplexing unit 800 and reconstructs a frequency spectrum, coding band mode information, and a scale factor by using a Huffman coding method. The context-dependent bitplane decoding unit 810 receives prejudice coding band mode information, a scale factor of prejudice coding, and a frequency spectrum of prejudice coding, and outputs coding band mode values, a decoding cosmetic indication of the scale factor, and quantization values of the frequency spectrum.

The PQ-SPSC module 820 receives the result output from the context-dependent bitplane decoding unit 810 and performs side-polar coordination stereo decoding on the frequency spectrum of the result. Here, the PQ-SPSC module 820 performs the side-polar coordination stereo decoding by receiving coupling information between the frequency spectrum and side-polar coordination stereo signals and then outputs a quantization frequency spectrum.

The inverse quantization unit 830 inverse quantizes the result output from the PQ-SPSC module 820.

The multi-resolution synthesis unit 840 receives the result output from the inverse quantization unit 830 and performs multi-resolution synthesis on audio spectrum coefficients of the received signal that instantaneously varies. In more detail, the multi-resolution synthesis unit 840 may improve the decoding efficiency by performing the multi-resolution synthesis on the result output from the inverse quantization unit 830 if multi-resolution analysis has been performed on an audio signal received from the encoding terminal. Here, the multi-resolution synthesis unit 840 receives an inverse quantization spectrum/difference spectrum and outputs a reconstruction spectrum/difference spectrum.

The inverse frequency linear prediction performance unit 850 combines the result output from the multi-resolution synthesis unit 840 and the result of frequency linear prediction by the encoding terminal which is received from the demultiplexing unit 800, and performs inverse vector quantization on the combined result. In more detail, if frequency linear prediction has been performed on the audio signal received from the encoding terminal, the inverse frequency linear prediction performance unit 850 may improve the decoding efficiency by combining the result of the frequency linear prediction and the result output from the inverse quantization unit 830 or the multi-resolution synthesis unit 840. Here, the inverse frequency linear prediction performance unit 850 efficiently improves the decoding efficiency by employing a frequency domain prediction technology and a vector quantization technology of prediction coefficients. The inverse frequency linear prediction performance unit 850 receives difference spectrum coefficients and vector indices and outputs MDCT spectrum coefficients.

The context-dependent bitplane decoding unit 810, the PQ-SPSC module 820, the inverse quantization unit 830, the multi-resolution synthesis unit 840, and the inverse frequency linear prediction performance unit 850 decode an encoded low band signal and thus may be collectively referred to as a low band decoding unit.

The inverse MDCT application unit 860 performs an inverse operation of the conversion performed by the encoding terminal. The inverse MDCT application unit 860 performs inverse MDCT on a low band signal output from the multi-resolution synthesis unit 840 and the inverse frequency linear prediction performance unit 850 so as to convert the low band signal from the frequency domain to the time domain. Here, the inverse MDCT application unit 860 receives frequency spectrum coefficients obtained from the result of inverse quantization by the multi-resolution synthesis unit 840 or the inverse frequency linear prediction performance unit 850, and outputs reconstructed audio data that corresponds to a low band.

The conversion unit 865 converts the low band signal converted to the time domain by the inverse MDCT application unit 860 from the time domain to the frequency domain or the time/frequency domain by using a conversion method. For example, the conversion unit 865 may convert the low band signal by using an MDST method, a FFT method, or a QMF method. Here, the MDCT method can also be used. However, if the MDCT method is used, the previous embodiment of FIG. 7 is more efficient than the current embodiment.

The bandwidth extension decoding unit 870 decodes the encoded bandwidth extension information and generates a high band signal from the low band signal output from the conversion unit 865 by using the decoded bandwidth extension information. Here, the bandwidth extension decoding unit 870 generates the high band signal by applying the decoded bandwidth extension information to the low band signal based on the fact that a high correlation exists between the low band signal and the high band signal. Here, the bandwidth extension information represents a characteristic of the high band signal and includes various pieces of information, such as an energy level and an envelope, of the high band signal.

The inverse conversion unit 880 inverse converts the high band signal decoded by the bandwidth extension decoding unit 870 from the frequency domain or the time/frequency domain to the time domain by using a conversion method other than the MDCT method. Here, the conversion unit 865 and the inverse conversion unit 880 use the same conversion method. For example, the inverse conversion unit 880 may use the MDST method, the FFT method, or the QMF method.

The band combination unit 890 combines the low band signal converted to the time domain by the inverse MDCT application unit 860 and the high band signal converted to the time domain by the inverse conversion unit 880 so as to output the result as an output signal OUT.

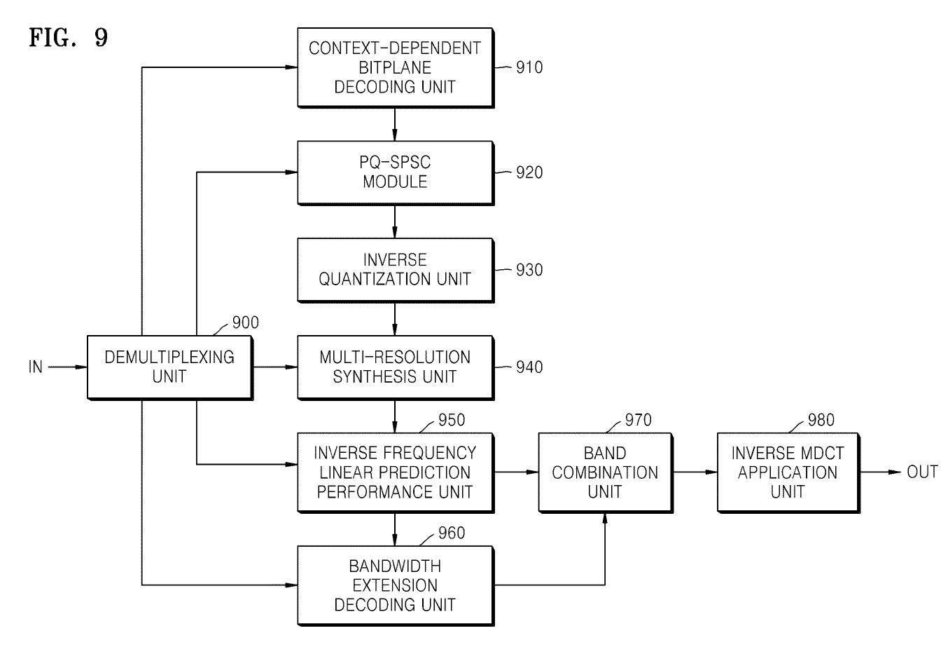

FIG. 9 is a block diagram of an apparatus to decode an audio signal, according to another embodiment of the present invention.

Referring to FIG. 9, the apparatus includes a demultiplexing unit 900, a context-dependent bitplane decoding unit 910, a PQ-SPSC module 920, an inverse quantization unit 930, a multi-resolution synthesis unit 940, an inverse frequency linear prediction performance unit 950, a bandwidth extension decoding unit 960, a band combination unit 970, and an inverse MDCT application unit 980.

The demultiplexing unit 900 receives and demultiplexes a bitstream output from an encoding terminal. In more detail, the demultiplexing unit 900 splits the bitstream into data pieces corresponding to various data levels, and analyzes and outputs information of the bitstream with regard to the data pieces. Here, the information output from the demultiplexing unit 900 includes analysis information on an audio spectrum to be used by the PQ-SPSC module 920, quantization values and other reconstruction information, reconstruction information of a quantization spectrum, information on context-dependant bitplane decoding, information on quantization wide-polar coordination stereo decoding, signal type information, information on frequency linear prediction and vector quantization, and encoded bandwidth extension information.

The context-dependent bitplane decoding unit 910 performs context-dependent decoding on an encoded bitplane. Here, the context-dependent bitplane decoding unit 910 receives the information output from the demultiplexing unit 900 and reconstructs a frequency spectrum, coding band mode information, and a scale factor by using a Huffman coding method. The context-dependent bitplane decoding unit 910 receives prejudice coding band mode information, a scale factor of prejudice coding, and a frequency spectrum of prejudice coding, and outputs coding band mode values, a decoding cosmetic indication of the scale factor, and quantization values of the frequency spectrum.

The PQ-SPSC module 920 receives the result output from the context-dependent bitplane decoding unit 910 and performs side-polar coordination stereo decoding on the frequency spectrum of the result. Here, the PQ-SPSC module 920 performs the side-polar coordination stereo decoding by receiving coupling information between the frequency spectrum and side-polar coordination stereo signals and then outputs a quantization frequency spectrum.

The inverse quantization unit 930 inverse quantizes the result output from the PQ-SPSC module 920.

The multi-resolution synthesis unit 940 receives the result output from the inverse quantization unit 930 and performs multi-resolution synthesis on audio spectrum coefficients of the received signal that change abruptly. In more detail, the multi-resolution synthesis unit 940 may improve the decoding efficiency by performing the multi-resolution synthesis on the result output from the inverse quantization unit 930 if multi-resolution analysis has been performed on an audio signal received from the encoding terminal. Here, the multi-resolution synthesis unit 940 receives an inverse quantization spectrum/difference spectrum and outputs a reconstruction spectrum/difference spectrum.

The inverse frequency linear prediction performance unit 950 combines the result output from the multi-resolution synthesis unit 940 and the result of frequency linear prediction by the encoding terminal which is received from the demultiplexing unit 900, and performs inverse vector quantization on the combined result. In more detail, if frequency linear prediction has been performed on the audio signal received from the encoding terminal, the inverse frequency linear prediction performance unit 950 may improve the decoding efficiency by combining the result of the frequency linear prediction and the result output from the inverse quantization unit 930 or the multi-resolution synthesis unit 940. Here, the inverse frequency linear prediction performance unit 950 efficiently improves the decoding efficiency by employing a frequency domain prediction technology and a vector quantization technology of prediction coefficients. The inverse frequency linear prediction performance unit 950 receives difference spectrum coefficients and vector indices and outputs MDCT spectrum coefficients.

The context-dependent bitplane decoding unit 910, the PQ-SPSC module 920, the inverse quantization unit 930, the multi-resolution synthesis unit 940, and the inverse frequency linear prediction performance unit 950 decode an encoded low band signal and thus may be collectively referred to as a low band decoding unit.

The bandwidth extension decoding unit 960 decodes the encoded bandwidth extension information and generates a high band signal from the low band signal output from the multi-resolution synthesis unit 940 or the inverse frequency linear prediction performance unit 950 by using the decoded bandwidth extension information. Here, the bandwidth extension decoding unit 960 generates the high band signal by applying the decoded bandwidth extension information to the low band signal based on the fact that a high correlation exists between the low band signal and the high band signal. Here, the bandwidth extension information represents a characteristic of the high band signal and includes various pieces of information, such as an energy level and an envelope, of the high band signal.

The band combination unit 970 combines the low band signal output from the multi-resolution synthesis unit 940 or the inverse frequency linear prediction performance unit 950 and the high band signal decoded by the bandwidth extension decoding unit 960.

The inverse MDCT application unit 980 inverse converts the result output from the band combination unit 970 by performing inverse MDCT so as to output the result as an output signal OUT. Here, the inverse MDCT application unit 980 receives frequency spectrum coefficients obtained from the result of inverse quantization by the inverse frequency linear prediction performance unit 950 and outputs reconstructed audio data that corresponds to a low band.

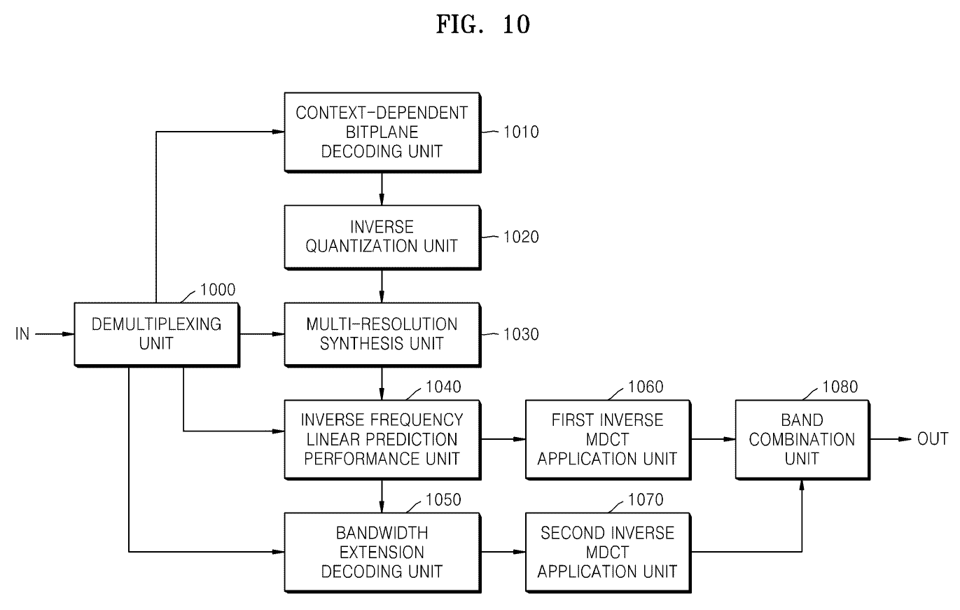

FIG. 10 is a block diagram of an apparatus to decode an audio signal, according to another embodiment of the present invention.

Referring to FIG. 10, the apparatus includes a demultiplexing unit 1000, a context-dependent bitplane decoding unit 1010, an inverse quantization unit 1020, a multi-resolution synthesis unit 1030, an inverse frequency linear prediction performance unit 1040, a bandwidth extension decoding unit 1050, a first inverse MDCT application unit 1060, a second inverse MDCT application unit 1070, and a band combination unit 1080.

The demultiplexing unit 1000 receives and demultiplexes a bitstream output from an encoding terminal. In more detail, the demultiplexing unit 1000 splits the bitstream into data pieces corresponding to various data levels, and analyzes and outputs information of the bitstream with regard to the data pieces. Here, the information output from the demultiplexing unit 1000 includes analysis information on an audio spectrum, quantization values and other reconstruction information, reconstruction information of a quantization spectrum, information on context-dependant bitplane decoding, signal type information, information on frequency linear prediction and vector quantization, and encoded bandwidth extension information.

The context-dependent bitplane decoding unit 1010 performs context-dependent decoding on an encoded bitplane. Here, the context-dependent bitplane decoding unit 1010 receives the information output from the demultiplexing unit 1000 and reconstructs a frequency spectrum, coding band mode information, and a scale factor by using a Huffman coding method. The context-dependent bitplane decoding unit 1010 receives prejudice coding band mode information, a scale factor of prejudice coding, and a frequency spectrum of prejudice coding, and outputs coding band mode values, a decoding cosmetic indication of the scale factor, and quantization values of the frequency spectrum.

The inverse quantization unit 1020 inverse quantizes the result output from the context-dependent bitplane decoding unit 1010.

The multi-resolution synthesis unit 1030 receives the result output from the inverse quantization unit 1020 and performs multi-resolution synthesis on audio spectrum coefficients of the received signal that changes abruptly. In more detail, the multi-resolution synthesis unit 1030 may improve the decoding efficiency by performing the multi-resolution synthesis on the result output from the inverse quantization unit 1020 if multi-resolution analysis has been performed on an audio signal received from the encoding terminal. Here, the multi-resolution synthesis unit 1030 receives an inverse quantization spectrum/difference spectrum and outputs a reconstruction spectrum/difference spectrum.

The inverse frequency linear prediction performance unit 1040 combines the result output from the multi-resolution synthesis unit 1030 and the result of frequency linear prediction by the encoding terminal which is received from the demultiplexing unit 1000. In more detail, if frequency linear prediction has been performed on the audio signal received from the encoding terminal, the inverse frequency linear prediction performance unit 1040 may improve the decoding efficiency by combining the result of the frequency linear prediction and the result output from the inverse quantization unit 1020 or the multi-resolution synthesis unit 1030. Here, the inverse frequency linear prediction performance unit 1040 efficiently improves the decoding efficiency by employing a frequency domain prediction technology and a vector quantization technology of prediction coefficients. The inverse frequency linear prediction performance unit 1040 receives difference spectrum coefficients and vector indices and outputs MDCT spectrum coefficients.

The context-dependent bitplane decoding unit 1010, the inverse quantization unit 1020, the multi-resolution synthesis unit 1030, and the inverse frequency linear prediction performance unit 1040 decode an encoded low band signal and thus may be collectively referred to as a low band decoding unit.

The bandwidth extension decoding unit 1050 decodes the encoded bandwidth extension information and generates a high band signal from the low band signal output from the multi-resolution synthesis unit 1030 or the inverse frequency linear prediction performance unit 1040 by using the decoded bandwidth extension information. Here, the bandwidth extension decoding unit 1050 generates the high band signal by applying the decoded bandwidth extension information to the low band signal based on the fact that a high correlation exists between the low band signal and the high band signal. Here, the bandwidth extension information represents a characteristic of the high band signal, and includes various pieces of information, such as an energy level and an envelope, of the high band signal.

The first inverse MDCT application unit 1060 performs an inverse operation of the conversion performed by the encoding terminal. The first inverse MDCT application unit 1060 performs inverse MDCT on a low band signal output from the multi-resolution synthesis unit 1030 and the inverse frequency linear prediction performance unit 1040 so as to convert the low band signal from the frequency domain to the time domain. Here, the first inverse MDCT application unit 1060 receives frequency spectrum coefficients obtained from the result of inverse quantization by the multi-resolution synthesis unit 1030 or the inverse frequency linear prediction performance unit 1040 and outputs reconstructed audio data that corresponds to a low band.

The second inverse MDCT application unit 1070 performs inverse MDCT on the high band signal decoded by the bandwidth extension decoding unit 1050 so as to convert the high band signal from the frequency domain to the time domain.

The band combination unit 1080 combines the low band signal converted to the time domain by the first inverse MDCT application unit 1060 and the high band signal converted to the time domain by the second inverse MDCT application unit 1070 so as to output the result as an output signal OUT.

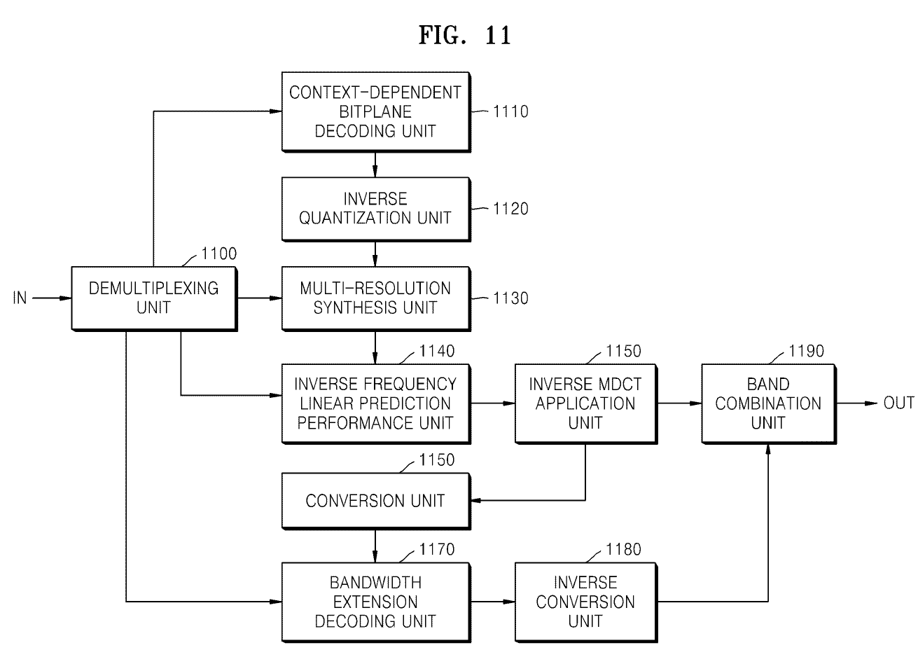

FIG. 11 is a block diagram of an apparatus to decode an audio signal, according to another embodiment of the present invention.

Referring to FIG. 11, the apparatus includes a demultiplexing unit 1100, a context-dependent bitplane decoding unit 1110, an inverse quantization unit 1120, a multi-resolution synthesis unit 1130, an inverse frequency linear prediction performance unit 1140, an inverse MDCT application unit 1150, a conversion unit 1160, a bandwidth extension decoding unit 1170, an inverse conversion unit 1180, and a band combination unit 1190.

The demultiplexing unit 1100 receives and demultiplexes a bitstream output from an encoding terminal. In more detail, the demultiplexing unit 1100 splits the bitstream into data pieces corresponding to various data levels, and analyzes and outputs information of the bitstream with regard to the data pieces. Here, the information output from the demultiplexing unit 1100 includes analysis information on an audio spectrum, quantization values and other reconstruction information, reconstruction information of a quantization spectrum, information on context-dependant bitplane decoding, signal type information, information on frequency linear prediction and vector quantization, and encoded bandwidth extension information.

The context-dependent bitplane decoding unit 1110 performs context-dependent decoding on an encoded bitplane. Here, the context-dependent bitplane decoding unit 1110 receives the information output from the demultiplexing unit 1100 and reconstructs a frequency spectrum, coding band mode information, and a scale factor by using a Huffman coding method. The context-dependent bitplane decoding unit 1110 receives prejudice coding band mode information, a scale factor of prejudice coding, and a frequency spectrum of prejudice coding, and outputs coding band mode values, a decoding cosmetic indication of the scale factor, and quantization values of the frequency spectrum.

The inverse quantization unit 1120 inverse quantizes the result output from the context-dependent bitplane decoding unit 1110.

The multi-resolution synthesis unit 1130 receives the result output from the inverse quantization unit 1120 and performs multi-resolution synthesis on audio spectrum coefficients of the received signal that instantaneously varies. In more detail, the multi-resolution synthesis unit 1130 may improve the decoding efficiency by performing the multi-resolution synthesis on the result output from the inverse quantization unit 1120, if multi-resolution analysis has been performed on an audio signal received from the encoding terminal. Here, the multi-resolution synthesis unit 1130 receives an inverse quantization spectrum/difference spectrum and outputs a reconstruction spectrum/difference spectrum.

The inverse frequency linear prediction performance unit 1140 combines the result output from the multi-resolution synthesis unit 1130 and the result of frequency linear prediction by the encoding terminal which is received from the demultiplexing unit 1100, and performs inverse vector quantization on the combined result. In more detail, if frequency linear prediction has been performed on the audio signal received from the encoding terminal, the inverse frequency linear prediction performance unit 1140 may improve the decoding efficiency by combining the result of the frequency linear prediction and the result output from the inverse quantization unit 1120 or the multi-resolution synthesis unit 1130. Here, the inverse frequency linear prediction performance unit 1140 improves the decoding efficiency by employing a frequency domain prediction technology and a vector quantization technology of prediction coefficients. The inverse frequency linear prediction performance unit 1140 receives difference spectrum coefficients and vector indices and outputs MDCT spectrum coefficients.

The context-dependent bitplane decoding unit 1110, the inverse quantization unit 1120, the multi-resolution synthesis unit 1130, and the inverse frequency linear prediction performance unit 1140 decode an encoded low band signal and thus may be collectively referred to as a low band decoding unit.

The inverse MDCT application unit 1150 performs an inverse operation of the conversion performed by the encoding terminal. The inverse MDCT application unit 1150 performs inverse MDCT on a low band signal output from the multi-resolution synthesis unit 1130 and the inverse frequency linear prediction performance unit 1140 so as to convert the low band signal from the frequency domain to the time domain. Here, the inverse MDCT application unit 1150 receives frequency spectrum coefficients obtained from the result of inverse quantization by the multi-resolution synthesis unit 1130 or the inverse frequency linear prediction performance unit 1140 and outputs reconstructed audio data that corresponds to a low band.

The conversion unit 1160 converts the low band signal converted to the time domain by the inverse MDCT application unit 1150 from the time domain to the frequency domain or the time/frequency domain by using a conversion method. For example, the conversion unit 1160 may convert the low band signal by using an MDST method, a FFT method, or a QMF method. Here, the MDCT method can also be used. However, if the MDCT method is used, the previous embodiment of FIG. 10 is more efficient than the current embodiment.

The bandwidth extension decoding unit 1170 decodes the encoded bandwidth extension information and generates a high band signal from the low band signal output from the conversion unit 1160 by using the decoded bandwidth extension information. Here, the bandwidth extension decoding unit 1170 generates the high band signal by applying the decoded bandwidth extension information to the low band signal based on the fact that a high correlation exists between the low band signal and the high band signal. Here, the bandwidth extension information represents a characteristic of the high band signal and includes various pieces of information, such as an energy level and an envelope, of the high band signal.

The inverse conversion unit 1180 inverse converts the high band signal decoded by the bandwidth extension decoding unit 1170 from the frequency domain or the time/frequency domain to the time domain by using a conversion method other than the MDCT method. Here, the conversion unit 1160 and the inverse conversion unit 1180 use the same conversion method. For example, the inverse conversion unit 1180 may use the MDST method, the FFT method, or the QMF method.

The band combination unit 1190 combines the low band signal converted to the time domain by the inverse MDCT application unit 1150 and the high band signal converted to the time domain by the inverse conversion unit 1180 so as to output the result as an output signal OUT.

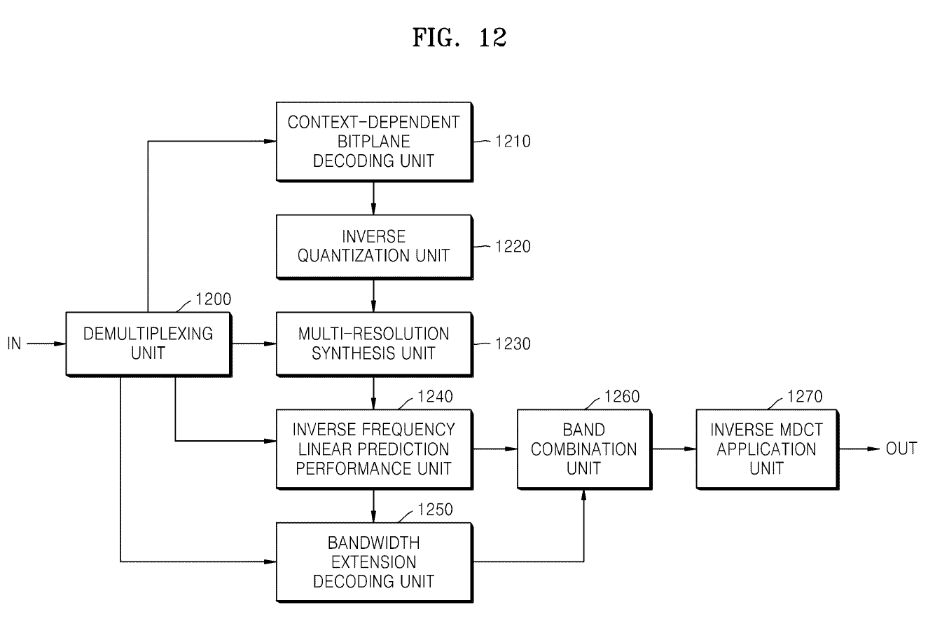

FIG. 12 is a block diagram of an apparatus to decode an audio signal, according to another embodiment of the present invention.

Referring to FIG. 12, the apparatus includes a demultiplexing unit 1200, a context-dependent bitplane decoding unit 1210, an inverse quantization unit 1220, a multi-resolution synthesis unit 1230, an inverse frequency linear prediction performance unit 1240, a bandwidth extension decoding unit 1250, a band combination unit 1260, and an inverse MDCT application unit 1270.

The demultiplexing unit 1200 receives and demultiplexes a bitstream output from an encoding terminal. In more detail, the demultiplexing unit 1200 splits the bitstream into data pieces corresponding to various data levels, and analyzes and outputs information of the bitstream with regard to the data pieces. Here, the information output from the demultiplexing unit 1200 includes analysis information on an audio spectrum, quantization values and other reconstruction information, reconstruction information of a quantization spectrum, information on context-dependent bitplane decoding, signal type information, information on frequency linear prediction and vector quantization, and encoded bandwidth extension information.

The context-dependent bitplane decoding unit 1210 performs context-dependent decoding on an encoded bitplane. Here, the context-dependent bitplane decoding unit 1210 receives the information output from the demultiplexing unit 1200 and reconstructs a frequency spectrum, coding band mode information, and a scale factor by using a Huffman coding method. The context-dependent bitplane decoding unit 1210 receives prejudice coding band mode information, a scale factor of prejudice coding, and a frequency spectrum of prejudice coding, and outputs coding band mode values, a decoding cosmetic indication of the scale factor, and quantization values of the frequency spectrum.

The inverse quantization unit 1220 inverse quantizes the result output from the context-dependent bitplane decoding unit 1210.

The multi-resolution synthesis unit 1230 receives the result output from the inverse quantization unit 1220 and performs multi-resolution synthesis on audio spectrum coefficients of the received signal that change abruptly. In more detail, the multi-resolution synthesis unit 1230 may improve the decoding efficiency by performing the multi-resolution synthesis on the result output from the inverse quantization unit 1220 if multi-resolution analysis has been performed on an audio signal received from the encoding terminal. Here, the multi-resolution synthesis unit 1230 receives an inverse quantization spectrum/difference spectrum and outputs a reconstruction spectrum/difference spectrum.

The inverse frequency linear prediction performance unit 1240 combines the result output from the multi-resolution synthesis unit 1230 and the result of frequency linear prediction by the encoding terminal, which is received from the demultiplexing unit 1200, and performs inverse vector quantization on the combined result. In more detail, if frequency linear prediction has been performed on the audio signal received from the encoding terminal, the inverse frequency linear prediction performance unit 1240 may improve the decoding efficiency by combining the result of the frequency linear prediction and the result output from the inverse quantization unit 1220 or the multi-resolution synthesis unit 1230. Here, the inverse frequency linear prediction performance unit 1240 efficiently improves the decoding efficiency by employing a frequency domain prediction technology and a vector quantization technology of prediction coefficients. The inverse frequency linear prediction performance unit 1240 receives difference spectrum coefficients and vector indices and outputs MDCT spectrum coefficients.

The context-dependent bitplane decoding unit 1210, the inverse quantization unit 1220, the multi-resolution synthesis unit 1230, and the inverse frequency linear prediction performance unit 1240 decode an encoded low band signal and thus may be collectively referred to as a low band decoding unit.

The bandwidth extension decoding unit 1250 decodes the encoded bandwidth extension information and generates a high band signal from the low band signal output from the multi-resolution synthesis unit 1230 or the inverse frequency linear prediction performance unit 1240 by using the decoded bandwidth extension information. Here, the bandwidth extension decoding unit 1250 generates the high band signal by applying the decoded bandwidth extension information to the low band signal based on the fact that a high correlation exists between the low band signal and the high band signal. Here, the bandwidth extension information represents a characteristic of the high band signal and includes various pieces of information, such as an energy level and an envelope, of the high band signal.

The band combination unit 1260 combines the low band signal output from the multi-resolution synthesis unit 1230 or the inverse frequency linear prediction performance unit 1240 and the high band signal decoded by the bandwidth extension decoding unit 1250.

The inverse MDCT application unit 1270 inverse converts the result output from the band combination unit 1260 by performing inverse MDCT so as to output the result as an output signal OUT. Here, the inverse MDCT application unit 1270 receives frequency spectrum coefficients obtained from the result of inverse quantization by the inverse frequency linear prediction performance unit 1240 and outputs reconstructed audio data that corresponds to a low band.

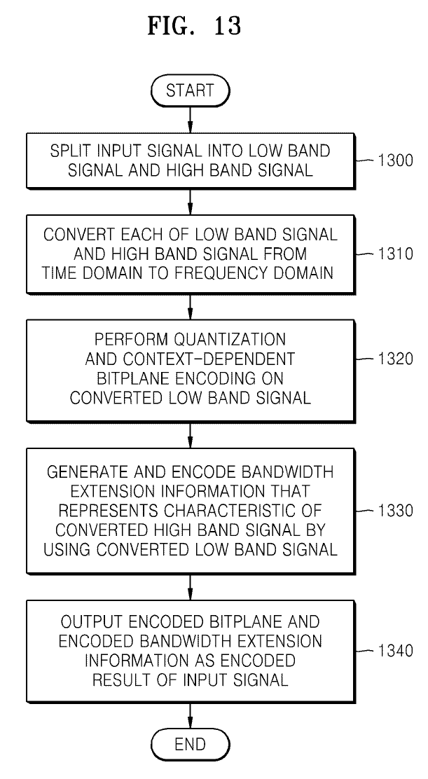

FIG. 13 is a flowchart of a method of encoding an audio signal, according to an embodiment of the present invention.

The method according to the current embodiment corresponds to sequential processes of the apparatus illustrated in FIG. 4. Thus, the method will be described in conjunction with FIG. 4 and repeated descriptions will be omitted.

Referring to FIG. 13, in operation 1300, the band splitting unit 400 splits an input signal into a low band signal and a high band signal.

In operation 1310, the first and second MDCT application units 410 and 460 convert the low band signal and the high band signal from the time domain to the frequency domain, respectively.

In operation 1320, a low band encoding unit performs quantization and context-dependent bitplane encoding on the converted low band signal. Here, the low band encoding unit may include the frequency linear prediction performance unit 420, the multi-resolution analysis unit 430, the quantization unit 440, and the context-dependent bitplane encoding unit 450. In more detail, the frequency linear prediction performance unit 420 filters the converted low band signal by performing frequency linear prediction in accordance with a characteristic of the low band signal. The multi-resolution analysis unit 430 performs multi-resolution analysis on the converted or filtered low band signal in accordance with the characteristic of the low band signal. The quantization unit 440 quantizes the low band signal on which the multi-resolution analysis is performed and the context-dependent bitplane encoding unit 450 performs context-dependent bitplane encoding on the quantized low band signal.

In operation 1330, the bandwidth extension encoding unit 470 generates and encodes bandwidth extension information that represents a characteristic of the converted high band signal by using the converted low band signal.

In operation 1340, the multiplexing unit 480 multiplexes and outputs the encoded bitplane and the encoded bandwidth extension information as an encoded result of the input signal.

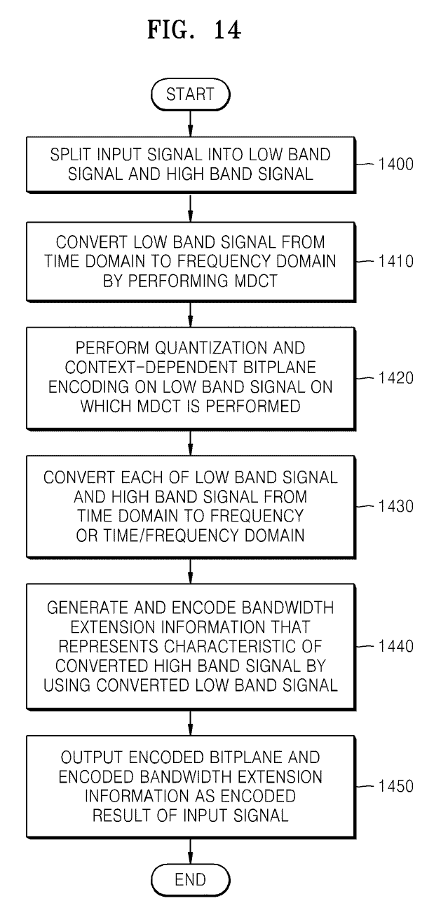

FIG. 14 is a flowchart of a method of encoding an audio signal, according to another embodiment of the present invention.

The method according to the current embodiment corresponds to sequential processes of the apparatus illustrated in FIG. 5. Thus, the method will be described in conjunction with FIG. 5 and repeated descriptions will be omitted.

Referring to FIG. 14, in operation 1400, the band splitting unit 500 splits an input signal into a low band signal and a high band signal.

In operation 1410, the MDCT application unit 510 performs MDCT on the low band signal so as to convert the low band signal from the time domain to the frequency domain.

In operation 1420, a low band encoding unit performs quantization and context-dependent bitplane encoding on the low band signal on which MDCT is performed. Here, the low band encoding unit may include the frequency linear prediction performance unit 520, the multi-resolution analysis unit 530, the quantization unit 540, and the context-dependent bitplane encoding unit 550. In more detail, the frequency linear prediction performance unit 520 filters the converted low band signal by performing frequency linear prediction in accordance with a characteristic of the low band signal. The multi-resolution analysis unit 530 performs multi-resolution analysis on the converted or filtered low band signal in accordance with the characteristic of the low band signal. The quantization unit 540 quantizes the low band signal on which the multi-resolution analysis is performed and the context-dependent bitplane encoding unit 550 performs context-dependent bitplane encoding on the quantized low band signal.

In operation 1430, the low band conversion unit 560 and the high band conversion unit 570 convert the low band signal and the high band signal from the time domain to the frequency domain or the time/frequency domain, respectively.

In operation 1440, the bandwidth extension encoding unit 580 generates and encodes bandwidth extension information that represents a characteristic of the converted high band signal by using the converted low band signal.

In operation 1450, the multiplexing unit 590 multiplexes and outputs the encoded bitplane and the encoded bandwidth extension information as an encoded result of the input signal.

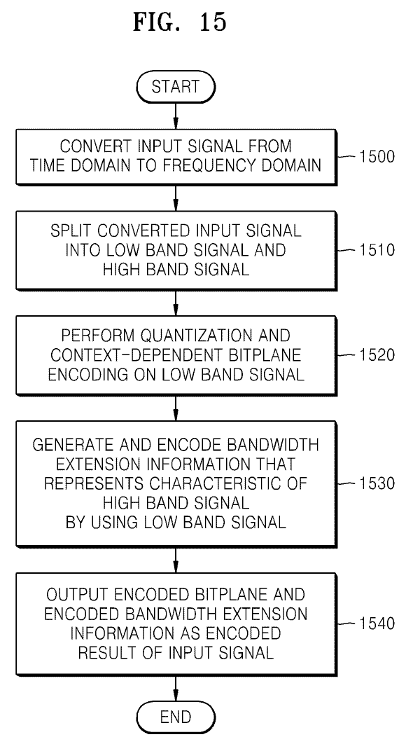

FIG. 15 is a flowchart of a method of encoding an audio signal, according to another embodiment of the present invention.

The method according to the current embodiment corresponds to sequential processes of the apparatus illustrated in FIG. 6. Thus, the method will be described in conjunction with FIG. 6 and repeated descriptions will be omitted.

Referring to FIG. 15, in operation 1500, the MDCT application unit 600 converts an input signal from the time domain to the frequency domain.

In operation 1510, the band splitting unit 610 splits the converted input signal into a low band signal and a high band signal.

In operation 1520, a low band encoding unit performs quantization and context-dependent bitplane encoding on the low band signal. Here, the low band encoding unit may include the frequency linear prediction performance unit 620, the multi-resolution analysis unit 630, the quantization unit 640, and the context-dependent bitplane encoding unit 650. In more detail, the frequency linear prediction performance unit 620 filters the converted low band signal by performing frequency linear prediction in accordance with a characteristic of the low band signal. The multi-resolution analysis unit 630 performs multi-resolution analysis on the converted or filtered low band signal in accordance with the characteristic of the low band signal. The quantization unit 640 quantizes the low band signal on which the multi-resolution analysis is performed and the context-dependent bitplane encoding unit 650 performs context-dependent bitplane encoding on the quantized low band signal.

In operation 1530, the bandwidth extension encoding unit 660 generates and encodes bandwidth extension information that represents a characteristic of the high band signal by using the low band signal.

In operation 1550, the multiplexing unit 670 multiplexes and outputs the encoded bitplane and the encoded bandwidth extension information as an encoded result of the input signal.

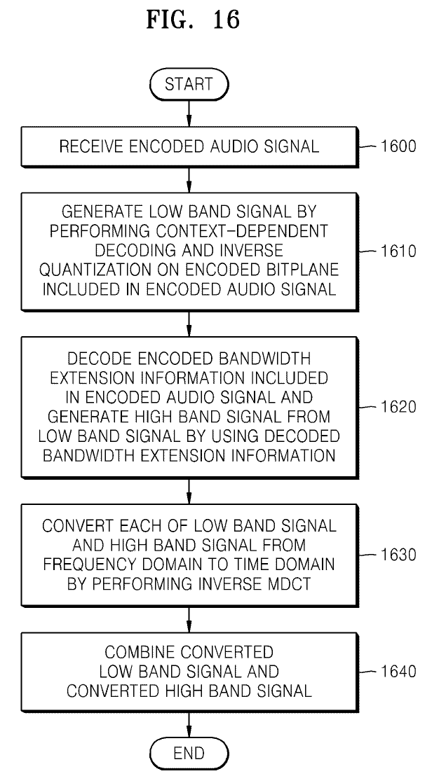

FIG. 16 is a flowchart of a method of decoding an audio signal, according to an embodiment of the present invention.

The method according to the current embodiment corresponds to sequential processes of the apparatus illustrated in FIG. 10. Thus, the method will be described in conjunction with FIG. 10 and repeated descriptions will be omitted.

In operation 1600, the demultiplexing unit 1000 receives an encoded audio signal. Here, the encoded audio signal includes an encoded bitplane and encoded bandwidth extension information of a low band.

In operation 1610, a low band decoding unit performs context-dependent decoding and inverse quantization on the encoded bitplane so as to generate a low band signal. Here, the low band decoding unit may include the context-dependent bitplane decoding unit 1010, the inverse quantization unit 1020, the multi-resolution synthesis unit 1030, and the inverse frequency linear prediction performance unit 1040. In more detail, the context-dependent bitplane decoding unit 1010 performs the context-dependent decoding on the encoded bitplane. The inverse quantization unit 1020 inverse quantizes the decoded bitplane. The multi-resolution synthesis unit 1030 performs multi-resolution synthesis on the inverse quantized bitplane if multi-resolution analysis has been performed on the encoded audio signal received by the demultiplexing unit 1000. If frequency linear prediction has been performed on the encoded audio signal received by the demultiplexing unit 1000, the inverse frequency linear prediction performance unit 1040 combines the result of the frequency linear prediction and the inverse quantized bitplane or the bitplane on which the multi-resolution synthesis is performed by using vector indices so as to generate the low band signal.

In operation 1620, the bandwidth extension decoding unit 1050 decodes the encoded bandwidth extension information and generates a high band signal from the low band signal by using the decoded bandwidth extension information.

In operation 1630, the first and second inverse MDCT application units 1060 and 1070 perform inverse MDCT on the low band signal and the high band signal so as to convert the low band signal and the high band signal from the frequency domain to the time domain, respectively.

In operation 1640, the band combination unit 1080 combines the converted low band signal and the converted high band signal.

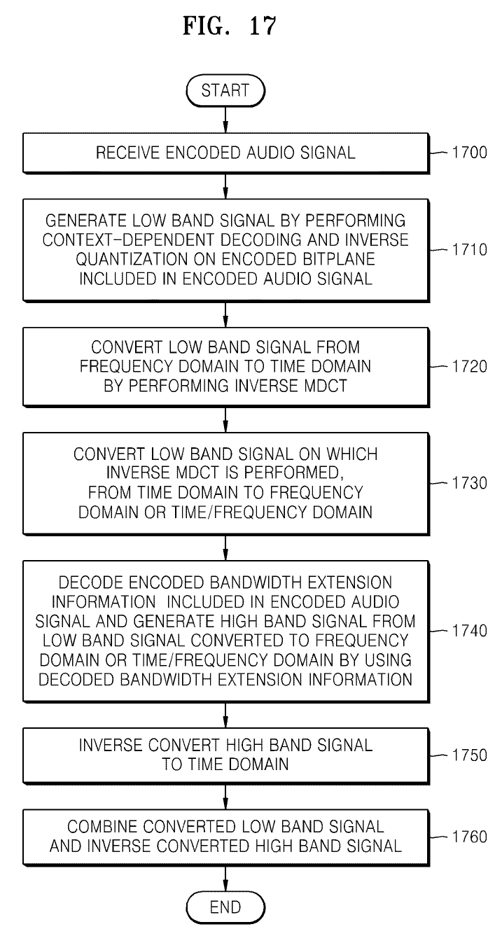

FIG. 17 is a flowchart of a method of decoding an audio signal, according to another embodiment of the present invention.

The method according to the current embodiment corresponds to sequential processes of the apparatus illustrated in FIG. 11. Thus, the method will be described in conjunction with FIG. 11 and repeated descriptions will be omitted.

In operation 1700, the demultiplexing unit 1100 receives an encoded audio signal. Here, the encoded audio signal includes an encoded bitplane and encoded bandwidth extension information of a low band.

In operation 1710, a low band decoding unit performs context-dependent decoding and inverse quantization on the encoded bitplane so as to generate a low band signal. Here, the low band decoding unit may include context-dependent bitplane decoding unit 1110, the inverse quantization unit 1120, the multi-resolution synthesis unit 1130, and the inverse frequency linear prediction performance unit 1140. In more detail, the context-dependent bitplane decoding unit 1110 performs the context-dependent decoding on the encoded bitplane. The inverse quantization unit 1120 inverse quantizes the decoded bitplane. The multi-resolution synthesis unit 1130 performs multi-resolution synthesis on the inverse quantized bitplane if multi-resolution analysis has been performed on the encoded audio signal received by the demultiplexing unit 1100. If frequency linear prediction has been performed on the encoded audio signal received by the demultiplexing unit 1100, the inverse frequency linear prediction performance unit 1140 combines the result of the frequency linear prediction and the inverse quantized bitplane or the bitplane on which the multi-resolution synthesis is performed by using vector indices so as to generate the low band signal.

In operation 1720, the inverse MDCT application unit 1150 performs inverse MDCT on the low band signal so as to convert the low band signal from the frequency domain to the time domain.

In operation 1730, the conversion unit 1160 converts the low band signal on which the inverse MDCT is performed, from the time domain to the frequency domain or the time/frequency domain.

In operation 1740, the bandwidth extension decoding unit 1170 decodes the encoded bandwidth extension information and generates a high band signal from the low band signal converted to the frequency domain or the time/frequency domain by using the decoded bandwidth extension information.

In operation 1750, the inverse conversion unit 1180 inverse converts the high band signal to the time domain.

In operation 1760, the band combination unit 1190 combines the converted low band signal and the inverse converted high band signal.

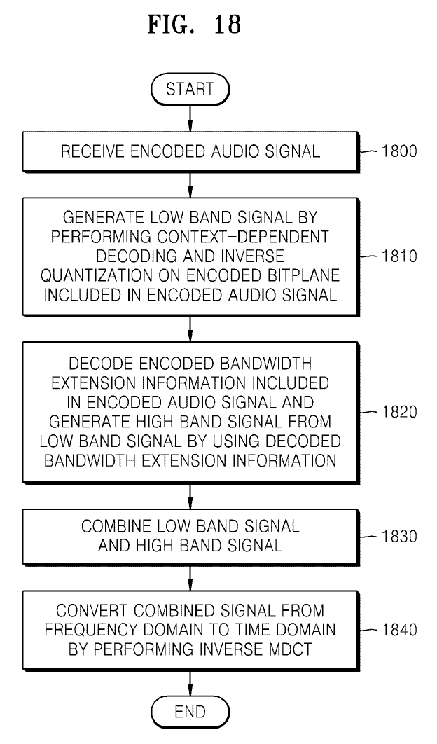

FIG. 18 is a flowchart of a method of decoding an audio signal, according to another embodiment of the present invention.

The method according to the current embodiment corresponds to sequential processes of the apparatus illustrated in FIG. 12. Thus, the method will be described in conjunction with FIG. 12 and repeated descriptions will be omitted.

In operation 1800, the demultiplexing unit 1200 receives an encoded audio signal. Here, the encoded audio signal includes an encoded bitplane and encoded bandwidth extension information of a low band.

In operation 1810, a low band decoding unit performs context-dependent decoding and inverse quantization on the encoded bitplane so as to generate a low band signal. Here, the low band decoding unit may include the context-dependent bitplane decoding unit 1210, the inverse quantization unit 1220, the multi-resolution synthesis unit 1230, and the inverse frequency linear prediction performance unit 1240. In more detail, the context-dependent bitplane decoding unit 1210 performs the context-dependent decoding on the encoded bitplane. The inverse quantization unit 1220 inverse quantizes the decoded bitplane. The multi-resolution synthesis unit 1230 performs multi-resolution synthesis on the inverse quantized bitplane if multi-resolution analysis has been performed on the encoded audio signal received by the demultiplexing unit 1200. If frequency linear prediction has been performed on the encoded audio signal received by the demultiplexing unit 1200, the inverse frequency linear prediction performance unit 1240 combines the result of the frequency linear prediction and the inverse quantized bitplane or the bitplane on which the multi-resolution synthesis is performed by using vector indices so as to generate the low band signal.

In operation 1820, the bandwidth extension decoding unit 1250 decodes the encoded bandwidth extension information and generates a high band signal from the low band signal by using the decoded bandwidth extension information.

In operation 1830, the band combination unit 1260 combines the low band signal and the high band signal.

In operation 1840, the inverse MDCT application unit 1270 performs inverse MDCT on the combined signal so as to convert the combined signal from the frequency domain to the time domain.

The invention can also be embodied as computer readable codes on a computer readable recording medium.

The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the present invention, by splitting an input signal into a low band signal and a high band signal, converting each of the low band signal and the high band signal from the time domain to the frequency domain, performing quantization and context-dependant bitplane encoding on the converted low band signal, generating and encoding bandwidth extension information that represents a characteristic of the converted high band signal, and outputting the encoded bitplane and the encoded bandwidth extension information as an encoded result of the input signal, high frequency components may be efficiently encoded at a restricted bit rate, thereby improving the quality of an audio signal.

Furthermore, by receiving an encoded audio signal, performing context-dependant decoding and inverse quantization on an encoded bitplane included in the encoded audio signal so as to generate a low band signal, decoding bandwidth extension information included in the encoded audio signal, generating a high band signal from the low band signal by using the decoded bandwidth extension information, performing inverse MDCT on the low band signal and the high band signal so as to convert the low band signal and the high band signal from the frequency domain to the time domain, and combining the converted low band signal and the converted high band signal, high frequency components may be efficiently decoded from a bitstream encoded at a restricted bit rate.

While the present invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of encoding an audio signal, the method comprising:
(a) splitting an input signal into a low band signal and a high band signal;
(b) converting each of the low band signal and the high band signal from a time domain to a frequency domain;
(c) performing quantization and context-dependent bitplane encoding on the converted low band signal;
(d) generating and encoding bandwidth extension information that represents a characteristic of the converted high band signal by using the converted low band signal; and
(e) outputting an encoded bitplane and the encoded bandwidth extension information as an encoded result of the input signal.

2. The method of claim 1, wherein (b) comprises converting each of the low band signal and the high band signal from the time domain to the frequency domain by performing modified discrete cosine transformation (MDCT) on each of the low band signal and the high band signal.

3. The method of claim 1, further comprising at least one of:
(f) filtering the converted low band signal by performing frequency linear prediction on the converted low band signal; and
(g) performing multi-resolution analysis on the converted low band signal,
wherein (c) comprises performing quantization and context-dependent bitplane encoding on the filtered low band signal or on the low band signal on which the multi-resolution analysis is performed.

4. The method of claim 3, wherein (f) comprises calculating coefficients of a linear prediction filter by performing frequency linear prediction on the converted low band signal and representing corresponding values of the coefficients by using vector indices, and
wherein (e) comprises outputting the encoded bitplane, the encoded bandwidth extension information, and the vector indices as an encoded result of the input signal.

5. The method of claim 1, wherein (b) comprises converting the low band signal from the time domain to the frequency domain by performing modified discrete cosine transformation (MDCT) on the low band signal; and
converting each of the low band signal and the high band signal from the time domain to the frequency domain or a time/frequency domain.

6. A method of decoding an audio signal, the method comprising:
(a) receiving an encoded audio signal;
(b) generating a low band signal by performing context-dependent decoding and inverse quantization on an encoded bitplane included in the encoded audio signal;
(c) decoding encoded bandwidth extension information included in the encoded audio signal and generating a high band signal from the low band signal by using the decoded bandwidth extension information;
(d) converting each of the low band signal and the high band signal from a frequency domain to a time domain by performing inverse modified discrete cosine transformation (MDCT) on each of the low band signal and the high band signal; and
(e) combining the converted low band signal and the converted high band signal.

7. The method of claim 6, wherein (b) further comprises at least one of:
performing multi-resolution synthesis on the inverse quantized bitplane; and
combining the result of frequency linear prediction by an encoding terminal and the inverse quantized bitplane by using vector indices included in the encoded audio signal

8. The method of claim 6, wherein (d) comprises converting the low band signal from the frequency domain to the time domain by performing inverse modified discrete cosine transformation (MDCT) on the low band signal; and
converting the low band signal on which the inverse MDCT is performed, from the time domain to the frequency domain or a time/frequency domain, and
(c) comprises decoding encoded bandwidth extension information included in the encoded audio signal and generating a high band signal from the low band signal converted to the frequency domain or the time/frequency domain by using the decoded bandwidth extension information.

9. The method of claim 8, further comprising inverse converting the high band signal to the time domain,
wherein (e) comprises combining the converted low band signal and the inverse converted high band signal.

10. A computer readable recording medium having recorded thereon a computer program for executing a method of decoding an audio signal, the method comprising:
(a) receiving an encoded audio signal;
(b) generating a low band signal by performing context-dependent decoding and inverse quantization on an encoded bitplane included in the encoded audio signal;
(c) decoding encoded bandwidth extension information included in the encoded audio signal and generating a high band signal from the low band signal by using the decoded bandwidth extension information;
(d) converting each of the low band signal and the high band signal from a frequency domain to a time domain by performing inverse modified discrete cosine transformation (MDCT) on each of the low band signal and the high band signal; and
(e) combining the converted low band signal and the converted high band signal.

11. An apparatus for encoding an audio signal, the apparatus comprising:
a band splitting unit for splitting an input signal into a low band signal and a high band signal;
a conversion unit for converting each of the low band signal and the high band signal from a time domain to a frequency domain;
a low band encoding unit for performing quantization and context-dependent bitplane encoding on the converted low band signal; and
a bandwidth extension encoding unit for generating and encoding bandwidth extension information that represents a characteristic of the converted high band signal by using the converted low band signal.

12. The apparatus of claim 11, wherein the conversion unit comprises:
a first MDCT application unit for converting the low band signal from the time domain to the frequency domain by performing modified discrete cosine transformation (MDCT) on the low band signal; and
a second MDCT application unit for converting the high band signal from the time domain to the frequency domain by performing the MDCT on the high band signal.

13. The apparatus of claim 11, wherein the low band encoding unit comprises at least one of:
a frequency linear prediction performance unit for filtering the converted low band signal by performing frequency linear prediction on the converted low band signal; and
a multi-resolution analysis unit for performing multi-resolution analysis on the converted low band signal, and
wherein the quantization and the context-dependent bitplane encoding are performed on the filtered low band signal or on the low band signal on which the multi-resolution analysis is performed.

14. The apparatus of claim 13, wherein the frequency linear prediction performance unit calculates coefficients of a linear prediction filter by performing frequency linear prediction on the converted low band signal and represents corresponding values of the coefficients by using vector indices.

15. The apparatus of claim 14, further comprising a multiplexing unit for multiplexing an encoded bitplane, the encoded bandwidth extension information, and the vector indices.

16. The apparatus of claim 11, wherein the conversion unit includes
an MDCT application unit for converting the low band signal from the time domain to the frequency domain by performing modified discrete cosine transformation (MDCT) on the low band signal; and
a domain conversion unit for converting each of the low band signal and the high band signal from the time domain to the frequency domain or a time/frequency domain, and
the low band encoding unit performs quantization and context-dependent bitplane encoding on the low band signal on which the MDCT is performed.

17. The apparatus of claim 16, wherein the low band encoding unit comprises at least one of:
a frequency linear prediction performance unit for filtering the low band signal on which the MDCT is performed by performing frequency linear prediction on the low band signal on which the MDCT is performed; and
a multi-resolution analysis unit for performing multi-resolution analysis on the low band signal on which the MDCT is performed, and
wherein the quantization and the context-dependent bitplane encoding are performed on the filtered low band signal or on the low band signal on which the multi-resolution analysis is performed.

18. The apparatus of claim 17, wherein the frequency linear prediction performance unit calculates coefficients of a linear prediction filter by performing frequency linear prediction on the low band signal on which the MDCT is performed and represents corresponding values of the coefficients by using vector indices.

19. The apparatus of claim 18, further comprising a multiplexing unit for multiplexing an encoded bitplane, the encoded bandwidth extension information, and the vector indices.

20. An apparatus for decoding an audio signal, the apparatus comprising:
a low band decoding unit for generating a low band signal by performing context-dependent decoding and inverse quantization on an encoded bitplane;
a bandwidth extension decoding unit for decoding encoded bandwidth extension information and generating a high band signal from the low band signal by using the decoded bandwidth extension information;
an inverse MDCT application unit for converting each of the low band signal and the high band signal from a frequency domain to a time domain by performing inverse modified discrete cosine transformation (MDCT) on each of the low band signal and the high band signal; and
a band combination unit for combining the converted low band signal and the converted high band signal.

21. The apparatus of claim 20, wherein the low band decoding unit comprises at least one of:
a multi-resolution synthesis unit for performing multi-resolution synthesis on the inverse quantized bitplane; and
an inverse frequency linear prediction performance unit for combining the result of frequency linear prediction by an encoding terminal and the inverse quantized bitplane by using vector indices.
